(19) United States
(12) Patent Application Publication
(10) Pub. No.: US 2021/0117805 A1
(43) Pub. Date: Apr. 22, 2021

(54) INFERENCE APPARATUS, AND INFERENCE METHOD

(71) Applicant: AXELL CORPORATION, Tokyo (JP)

(72) Inventor: Kazuki KYAKUNO, Tokyo (JP)

(73) Assignee: AXELL CORPORATION, Tokyo (JP)

(21) Appl. No.: 17/116,930

(22) Filed: Dec. 9, 2020

Related U.S. Application Data
(63) Continuation of application No. PCT/JP2019/032598, filed on Aug. 21, 2019.

(30) Foreign Application Priority Data
Oct. 10, 2018 (JP) 2018-191672

(51) Int. Cl. G06N 3/08; G06N 3/04

(52) U.S. Cl. CPC G06N 3/088; G06N 3/0454

(57) ABSTRACT

To provide a technique of preventing leakage of a network structure and a weight included in a learned model. An inference apparatus includes a determination unit, a decryption unit, and an inference unit. The determination unit determines whether encrypted learned model, in which a learned model including at least one of the structure and the weight of a neural network is encrypted, has been input. The decryption unit decrypts the encrypted learned model, when the encrypted learned model is input. The inference unit performs inference by using the decrypted learned model.

### CROSS-REFERENCE TO RELATED APPLICATIONS

This application is a continuation application of International Application PCT/JP2019/032598 filed on Aug. 21, 2019 entitled Inference Device, Inference Method, And Inference Program, and designated U.S., which claims priority to Japanese Application No. 2018-191672 filed Oct. 10, 2018, the entire contents of both of which are hereby incorporated herein by reference.

### FIELD

The embodiments discussed herein are related to an inference apparatus, and an inference method.

### BACKGROUND

In an application such as image recognition, speech recognition, and character recognition, inference processing using a neural network (NN) including an input layer, an intermediate layer, and an output layer has been used. The neural network includes a plurality of units (neurons) having an operation function in each layer of the input layer, the intermediate layer, and the output layer. Further, the units included in each layer of the neural network are combined with a unit each included in an adjacent layer by a weighted edge.

In the inference processing using the neural network, a technique that uses a neural network in which the intermediate layer is provided in plural to improve the accuracy of inference has been known. Machine learning using the neural network having a plurality of intermediate layers is referred to as “deep learning”. In the following descriptions, the neural network having a plurality of intermediate layers is also simply referred to as “neural network”.

In deep learning, since the neural network includes many units and edges to increase the scale of operation, a high-performance image processing apparatus is required. Further, since deep learning includes many parameters to be set, it is difficult for a user to set the parameter appropriately and cause the information processing apparatus to perform machine learning, thereby acquiring a learned model having high accuracy of inference. The learned model refers to a neural network in which machine learned parameters are set in a network structure that includes the network structure, the weight, and the bias of the neural network. The weight refers to a weight coefficient set to the edge between the units included in the neural network. The bias refers to an ignition threshold of the unit. Further, the network structure of the neural network is also simply referred to as “network structure”.

Therefore, conventionally, a developer of an application that uses inference processing using a neural network has been distributing a learned model acquired by performing deep learning to users. Accordingly, a user can perform inference processing using the learned model by a terminal held on the edge side. The terminal on the edge side refers to an information processing apparatus, for example, a mobile phone and a personal computer held by a user. In the following descriptions, the terminal on the edge side is also simply referred to as “edge terminal”.

As a related technique, there is a detection agent system using a mobile terminal that includes a mobile terminal and a server connected to the mobile terminal. The mobile terminal encrypts a feature vector included in information acquired from a user, and transmits the encrypted feature vector to the server as an input layer of the neural network. The server receives the encrypted feature vector to calculate a hidden layer from the input layer of the neural network, and transmits a calculation result of the hidden layer to the mobile terminal. Further, such a technique has been known that a mobile terminal further performs calculation of an output layer from the calculation result of the hidden layer acquired from the server.

As another related technique, there is a technique in which learning data is acquired from a user and a learned model acquired by performing machine learning on the server side is distributed to an edge terminal held by a user, thereby enabling to perform inference processing by the edge terminal. When the learned model is to be distributed to the edge terminal, the learned model is distributed to the edge terminal in an encrypted state via an encrypted communication route. Further, such a technique has been known that an edge terminal sets an expiration date until which the edge terminal can use the learned model, thereby protecting the learned model (for example, Japanese Patent Application Laid-open No. 2018-45679, and FUJITSU Cloud Service for OSS “Zinrai Platform service” Introduction, Internet <http://jp.fujitsu.com/solutions/cloud/k5/document/pdf/k5-zinrai-platform-function-overview.pdf>).

### SUMMARY

According to an aspect of the embodiments, an inference apparatus includes a processor which executes a process, wherein the process including outputting information representing contents of a learned model of a neural network, determining whether encrypted learned model in which the learned model is encrypted, has been input, stopping the outputting process, when the encrypted learned model is input, decrypting the encrypted learned model, when the encrypted learned model is input, and performing inference by using the decrypted learned model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of a processing system using a neural network according to a first embodiment.

FIG. 2 is a functional block diagram illustrating one mode of a customer apparatus according to the first embodiment.

FIG. 3 is a diagram illustrating an example of license information.

FIG. 4 is an explanatory diagram of one mode of processing to be performed by the customer apparatus according to the first embodiment.

FIG. 5 is a functional block diagram illustrating one mode of a development apparatus according to the first embodiment.

FIG. 6 is a diagram illustrating an example of customer management information.

FIG. 7 is a diagram illustrating an example of product information.

FIG. 8 is an explanatory diagram of one mode of processing to be performed by the development apparatus according to the first embodiment.

FIG. 9 is a functional block diagram illustrating one mode of a management apparatus according to the first embodiment.

FIG. 10 is a diagram illustrating an example of product management information.

FIG. 11 is a sequence diagram (part 1) illustrating an example of processing to be performed in the processing system according to the first embodiment.

FIG. 12 is a sequence diagram (part 2) illustrating an example of processing to be performed in the processing system according to the first embodiment.

FIG. 13 is a diagram illustrating an example of a processing system using a neural network according to a second embodiment.

FIG. 14 is a functional block diagram illustrating one mode of a customer apparatus according to the second embodiment.

FIG. 15 is a functional block diagram illustrating one mode of a development apparatus according to the second embodiment.

FIG. 16 is an explanatory diagram of an example of processing to be performed by the development apparatus according to the second embodiment.

FIG. 17 is a functional block diagram illustrating one mode of a processing apparatus according to the second embodiment.

FIG. 18 is a sequence diagram illustrating an example of processing to be performed in the processing system according to the second embodiment.

FIG. 19 is a diagram illustrating an example of a processing system using a neural network according to a third embodiment.

FIG. 20 is a functional block diagram illustrating one mode of a customer apparatus according to the third embodiment.

FIG. 21 is an explanatory diagram of an example of processing to be performed by the customer apparatus according to the third embodiment.

FIG. 22 is a functional block diagram illustrating one mode of a processing apparatus according to the third embodiment.

FIG. 23 is a sequence diagram illustrating an example of processing to be performed in the processing system according to the third embodiment.

FIG. 24 is a diagram illustrating an example of a processing system using a neural network according to a fourth embodiment.

FIG. 25 is a functional block diagram illustrating one mode of a customer apparatus according to the fourth embodiment.

FIG. 26 is a diagram illustrating the structure of a convolutional neural network.

FIG. 27 is a functional block diagram illustrating one mode of a development apparatus according to the fourth embodiment.

FIG. 28 is a functional block diagram illustrating one mode of a processing apparatus according to the fourth embodiment.

FIG. 29 is a sequence diagram illustrating an example of processing to be performed in the processing system according to the fourth embodiment.

FIG. 30 is a block diagram illustrating an example of a computer apparatus.

FIG. 31 is a diagram illustrating one mode of an encryption processing system using DH key exchange.

FIG. 32 is a diagram illustrating one mode of an encryption processing system using public key cryptography.

FIG. 33 is a diagram illustrating one mode of an encrypted header of an encrypted learned model.

### DESCRIPTION OF EMBODIMENTS

### First Embodiment

Processing using a neural network according to a first embodiment is described.

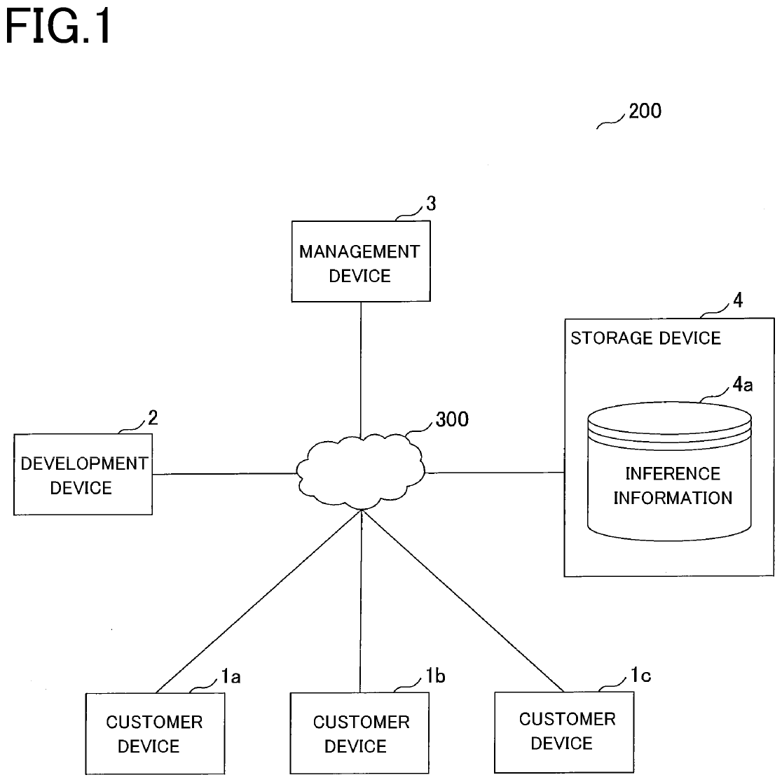

FIG. 1 is a diagram illustrating an example of a processing system using the neural network according to the first embodiment.

An outline of the processing using the neural network is described with reference to FIG. 1.

A processing system 200 includes, for example, customer apparatuses 1a, 1b, and 1c, a development apparatus 2, a management apparatus 3, and a storage apparatus 4. The customer apparatuses 1a, 1b, and 1c, the development apparatus 2, the management apparatus 3, and the storage apparatus 4 are connected to each other communicably via a network 300. Further, the customer apparatuses 1 a, 1b, and 1c, the development apparatus 2, the management apparatus 3, and the storage apparatus 4 are each, for example, a computer apparatus described later. In the following descriptions, the customer apparatus 1 a, the customer apparatus 1b, and the customer apparatus 1c may be simply referred to as “customer apparatus 1”, when these apparatuses are not particularly distinguished from each other.

The customer apparatus 1 is, for example, an information processing apparatus held by a user. The customer apparatus 1 is an example of an inference apparatus and an edge terminal that execute an application using inference processing. The development apparatus 2 is, for example, an information processing apparatus that performs, for example, generation of a learned model and creation of an application. The development apparatus 2 is an example of a learning apparatus held by a developer. The learned model may include the network structure, the weight, and the bias as separate pieces of data.

The management apparatus 3 is, for example, an information processing apparatus held by a manager. The management apparatus 3 generates license information for granting the use of a learned model. The storage apparatus 4 is, for example, an information processing apparatus held by the developer. The storage apparatus 4 is not limited to the information processing apparatus held by the developer, and may be, for example, an information processing apparatus such as a server apparatus operated by a third party that performs storage and distribution of data.

The development apparatus 2 performs deep learning by using a network structure set by the developer, to generate a learned model. Further, the development apparatus 2 creates an application to be used, by calling for an inference DLL (Dynamic Link Library: DLL) that performs inference processing. The development apparatus 2 requests the management apparatus 3 to register product information of the learned model. An entry point indicating a start point of a stub program, and the stub program that indicates a start point of the application at the time of executing the application and calls for the inference DLL may be attached to the application. The inference DLL is provided, for example, from a manager to the developer.

Upon reception of a request to register the product information of the learned model from the development apparatus 2, the management apparatus 3 generates product information including a common key and stores the product information. The management apparatus 3 transmits the product information to the development apparatus 2. The common key is an example of an encryption key and a decryption key.

Upon reception of the product information from the management apparatus 3, the development apparatus 2 encrypts the learned model by using the common key included in the product information. The development apparatus 2 transmits inference information 4a including the encrypted learned model, the inference DLL, and the application to the storage apparatus 4. Upon reception of the inference information 4a, the storage apparatus 4 stores therein the inference information 4a.

The customer apparatus 1 acquires the inference information 4a from the storage apparatus 4 in response to a request from a user. When the learned model included in the acquired inference information 4a has been encrypted, the user uses the customer apparatus 1 to request the development apparatus 2 to issue license information that grants the use of the learned model.

Upon reception of the request to issue license information from the customer apparatus 1, the development apparatus 2 requests the management apparatus 3 to generate license information. Upon reception of the request to generate license information from the development apparatus 2, the management apparatus 3 generates license information to which a common key included in the product information corresponding to the learned model is attached, and transmits the license information to the development apparatus 2.

Upon reception of the license information from the management apparatus 3, the development apparatus 2 transmits the license information to the customer apparatus 1. Upon reception of the license information from the development apparatus 2, the customer apparatus 1 uses the common key included in the license information to decrypt the encrypted learned model included in the inference information 4a, and performs inference processing. Specifically, when reading the encrypted learned model into the framework of the neural network, the customer apparatus 1 determines that the learned model has been encrypted, and automatically reads a license file. The customer apparatus 1 uses the common key included in the license information to decrypt the encrypted learned model. Determination as to whether the learned model has been encrypted may be incorporated as a part of the functions of the framework. In the following descriptions, the framework of the neural network may be simply referred to as “framework”.

As described above, the customer apparatus 1 determines whether the learned model has been encrypted by reading the learned model into the framework. The customer apparatus 1 reads in the license information when the learned model has been encrypted, and uses the common key included in the license information to decrypt the encrypted learned model. Therefore, the customer apparatus 1 can make it difficult to browse and copy the learned model on the user side, thereby enabling to prevent leakage of the network structure and the weight included in the learned model.

The processing system according to the first embodiment is described more specifically.

In the following descriptions, a case in which a learned model has been encrypted is described. The customer apparatus 1 according to the present invention determines that the learned model has not been encrypted when having acquired an unencrypted learned model, and automatically performs inference processing using the learned model.

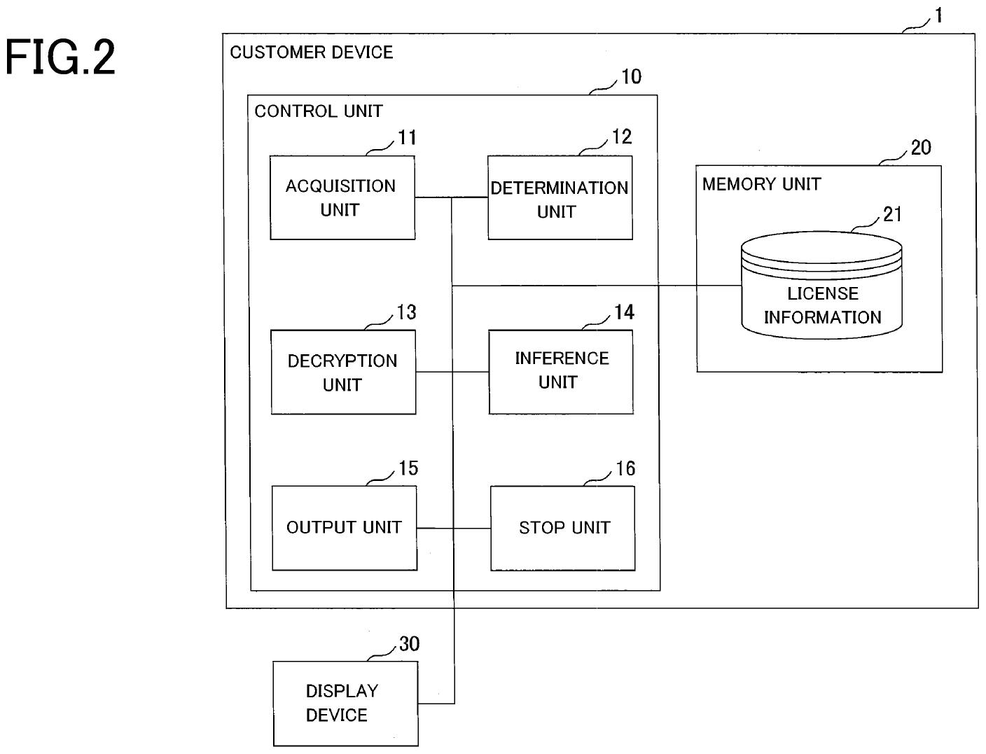

FIG. 2 is a functional block diagram illustrating one mode of the customer apparatus according to the first embodiment.

Processing to be performed by the customer apparatus 1 is described with reference to FIG. 2.

The customer apparatus 1 includes a control unit 10 and a memory unit 20. The customer apparatus 1 is connected to a display device 30 that displays thereon various pieces of information. The customer apparatus 1 may have a configuration including the display device 30.

The control unit 10 includes an acquisition unit 11, a determination unit 12, a decryption unit 13, an inference unit 14, an output unit 15, and a stop unit 16. The memory unit 20 memorizes therein license information 21 acquired from the development apparatus 2. The license information 21 is an example of permission information generated by the management apparatus 3.

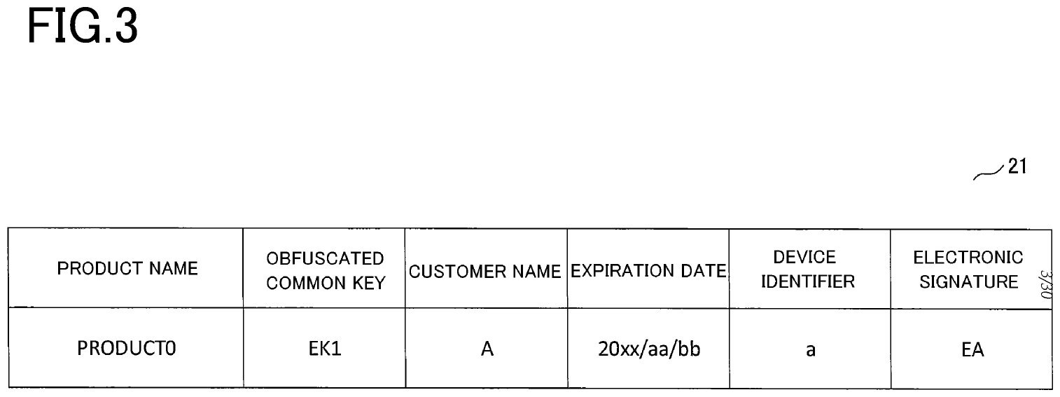

The license information 21 includes, for example, as illustrated in FIG. 3, a product name, an obfuscated common key, a customer name, an expiration date, a device identifier, and an electronic signature.

The product name is an identifier for identifying a learned model generated by the development apparatus 2.

The obfuscated common key is, for example, a cipher text in which a common key that encrypts and decrypts a learned model identified by a product name, which is generated by the management apparatus 3, is encrypted by a predetermined operation. The obfuscated common key is generated by the management apparatus 3.

The obfuscated common key may be a value acquired by performing an exclusive-OR operation between, for example, at least one of the product name, the customer name, the expiration date, and the device identifier included in the license information 21 and the common key. The obfuscated common key may be a value acquired by performing addition or subtraction operations between, for example, at least one of the customer name, the expiration date, and the device identifier included in the license information 21 and the common key. Further, the obfuscated common key may be a value acquired by encrypting the common key by, for example, a secret key in public key encryption.

The customer name is an identifier that identifies the user who uses the customer apparatus 1. For example, a customer name A memorized in the customer apparatus 1a is an identifier that identifies the user of the customer apparatus 1a.

The expiration date is information indicating a time limit until which use of the learned model is granted.

The device identifier is, for example, an identifier that identifies any one apparatus included in the customer apparatus 1. The apparatus included in the customer apparatus 1 is, for example, a CPU, an HDD, and the like. The identifier may be a device ID of, for example, the CPU, the HDD, and the like. The device identifier included in the license information 21 is an example of a first device identifier.

The electronic signature is information to be used for certifying that the contents of the license information 21 are not falsified. The electronic signature may be a value obtained by obtaining a value for the electronic signature acquired, for example, by using at least one of the product name, the customer name, the expiration date, and the device identifier included in the license information 21, and encrypting the value for the electronic signature by a secret key in public key encryption. The electronic signature is generated by the management device 3.

Descriptions are made with reference to FIG. 2.

The acquisition unit 11 acquires the inference information 4a including an encrypted learned model attached with an encryption identifier for identifying whether the learned model has been encrypted, the inference DLL, and an application from the storage apparatus 4.

Further, the acquisition unit 11 acquires the license information 21 by requesting the development apparatus 2 to issue the license information 21 in response to a request from a user. The request to issue the license information 21 includes a product name of a learned model for which licensing is requested, a customer name of the user, a desired expiration date, and a device identifier of a device included in the customer apparatus 1. The encryption identifier is information attached to the learned model by the development apparatus 2. As the device identifier, the user may set a device ID of an arbitrary apparatus included in the customer apparatus 1, or a device ID of a device selected by the customer apparatus 1 at the time of requesting to issue the license information 21 may be used.

The determination unit 12 determines whether an encrypted learned model in which a learned model (data) including at least one of the structure of a neural network and the weight of an edge included in the neural network is encrypted has been input. At this time, the determination unit 12 may determine whether an encrypted learned model has been input by referring to the encryption identifier attached to the encrypted learned model.

The decryption unit 13 decrypts the encrypted learned model upon input of the encrypted learned model. The decryption unit 13 may decrypt the encrypted learned model by decrypting the obfuscated common key included in the license information 21 and using the decrypted common key. The decryption unit 13 decrypts the obfuscated common key by performing an inverse operation to an operation used at the time of generating the obfuscated common key.

Further, the decryption unit 13 refers to the expiration date included in the license information 21, and when the time at the time of decrypting the learned model is within the expiration date, the decryption unit 13 may decrypt the encrypted learned model. The decryption unit 13 may decrypt the learned model when the device identifier included in the license information 21 and a device identifier for identifying any one device included in the customer apparatus match with each other. The device identifier for identifying a device included in the customer apparatus is an example of a second device identifier.

The inference unit 14 performs inference by using the decrypted learned model.

The output unit 15 outputs information included in the learned model. The information included in the learned model is the network structure, the weight, and the bias of the neural network. The output unit 15 may display the information included in the learned model, for example, on the display device 30.

The stop unit 16 stops an output process performed by the output unit 15, when the encrypted learned model is input. The output process is, for example, a part of the functions of the framework, and is a function of displaying the network structure, the weight, and the bias included in the learned model on the display device 30. Further, the output process may be, for example, a function of outputting the network structure, the weight, and the bias included in the learned model to a recording medium or the like, which is a part of the functions of the framework. That is, the stop unit 16 forbids a customer from browsing and acquiring the network structure when the encrypted learned model is input.

More specifically, the stop unit 16 stops the output process by the output unit 15, for example, with regard to the name of each layer in the neural network, the name of output data from the layer, the size of the output data from the layer, the summary of the network, and profile information of the network. The summary of the network is information in which, for example, the names of the layers and the size of the layers are enumerated. The profile information of the network is information including a processing time in each layer.

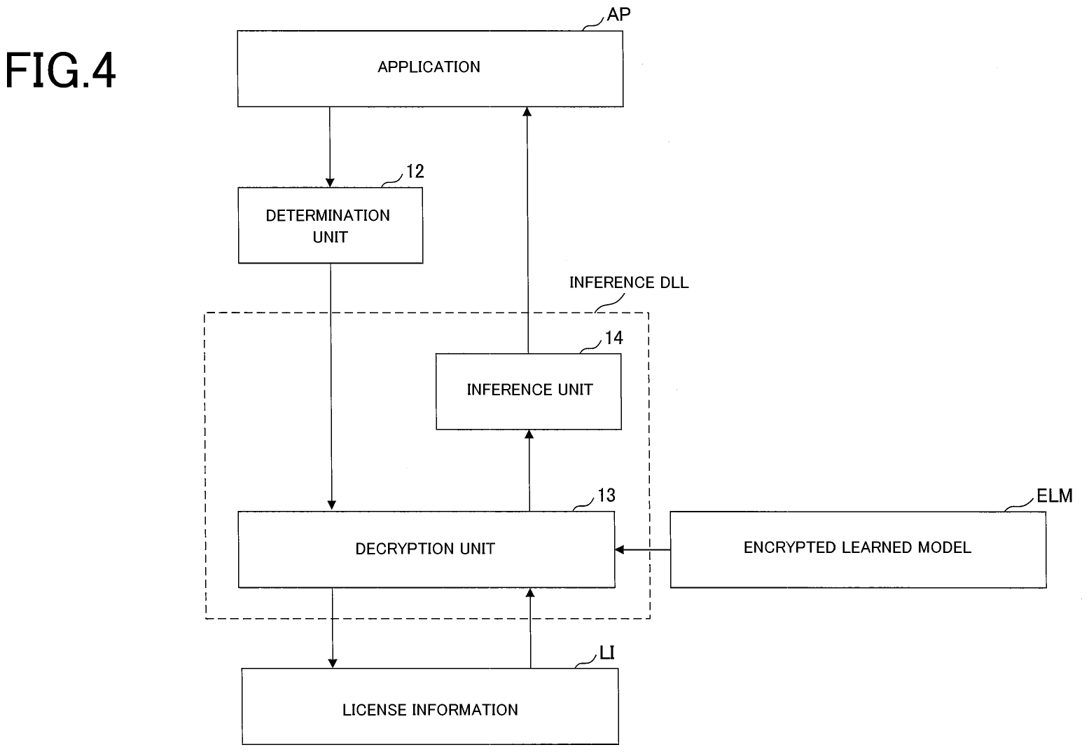

FIG. 4 is an explanatory diagram of one mode of processing to be performed by the customer apparatus according to the first embodiment.

The inference processing is described in more detail with reference to FIG. 4. As illustrated in FIG. 4, in the customer apparatus 1, inference processing is performed by the control unit 10 that executes the inference DLL. The inference DLL functions as the decryption unit 13 and the inference unit 14, for example, by being executed by the control unit 10.

When an application is executed by a user, the determination unit 12 determines whether a learned model has been encrypted by referring to an encryption identifier attached to the learned model acquired by the acquisition unit 11. The inference unit 14 performs inference processing by using the acquired learned model, when the learned model has not been encrypted.

When the acquired learned model has been encrypted, the determination unit 12 calls for the inference DLL including the decryption unit 13 and the inference unit 14.

The decryption unit 13 verifies an electronic signature included in the license information 21. For example, the decryption unit 13 decrypts the electronic signature by using a public key corresponding to the public key encryption that has been used at the time of generating the electronic signature. Further, the decryption unit 13 obtains a value for the electronic signature by performing the same operation as the operation at the time of generating the electronic signature, by using at least one of the product name, the customer name, the expiration date, and the device identifier included in the license information 21. When a value obtained by decrypting the electronic signature and the obtained value for the electronic signature match with each other, the decryption unit 13 approves the verification of the electronic signature. Accordingly, the decryption unit 13 confirms that the license information 21 has not been falsified.

After approving the electronic signature, the decryption unit 13 decrypts the obfuscated common key included in the license information 21. The decryption unit 13 then decrypts the encrypted learned model by using the decrypted common key.

The inference unit 14 performs inference processing by using the decrypted learned model. The inference unit 14 outputs an inference result to the application.

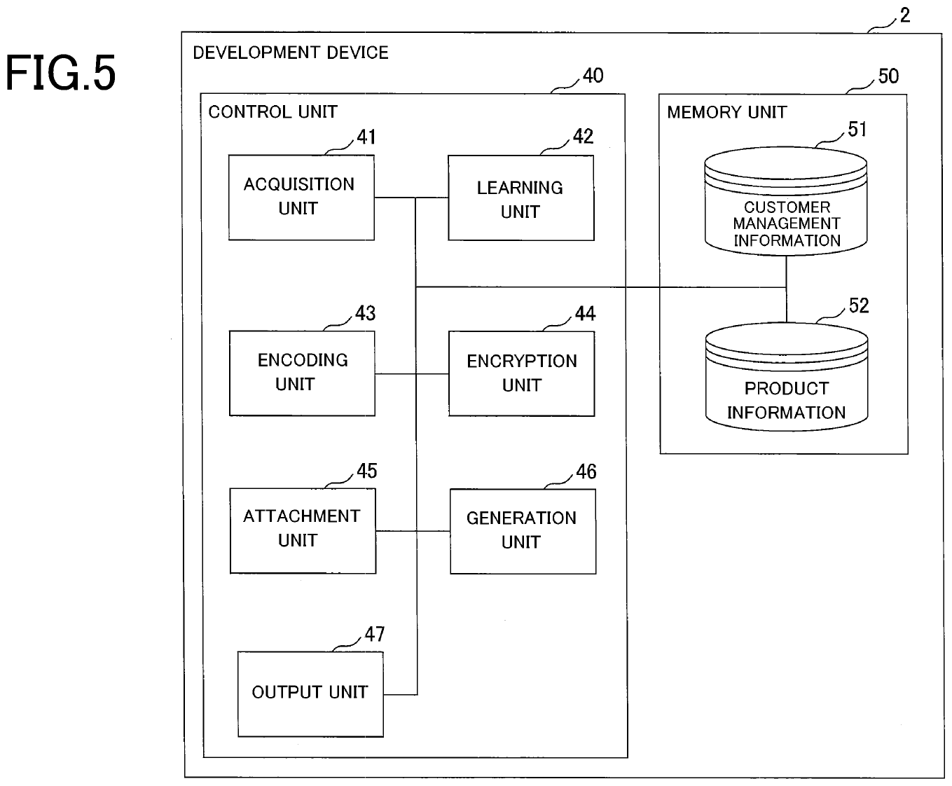

FIG. 5 is a functional block diagram illustrating one mode of the development apparatus according to the first embodiment.

Processing performed by the development apparatus 2 is described with reference to FIG. 5.

The development apparatus 2 includes a control unit 40 and a memory unit 50.

The control unit 40 includes an acquisition unit 41, a learning unit 42, an encoding unit 43, an encryption unit 44, an attachment unit 45, a generation unit 46, and an output unit 47. The memory unit 50 memorizes therein customer management information 51 acquired from the customer apparatus 1, and product information 52 acquired from the management apparatus 3.

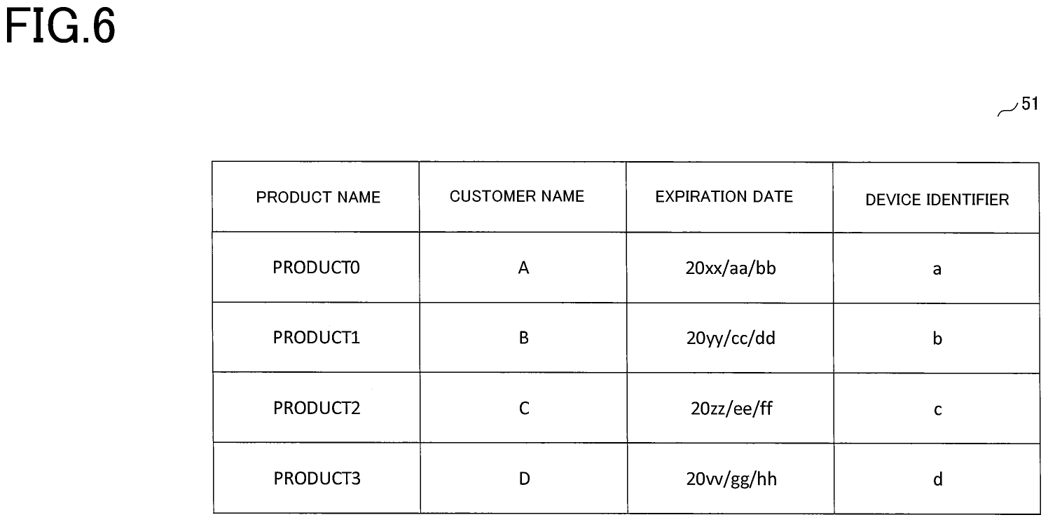

The customer management information 51 is information received together with a request to issue the license information 21 from a customer, and for example, includes a product name, a customer name, an expiration date, and a device identifier as illustrated in FIG. 6.

The product name is an identifier for identifying a learned model, for which licensing is requested from the customer apparatus 1.

The customer name is an identifier for identifying a user who has requested to issue the license information 21.

The expiration date is information indicating the time limit until which the use of the learned model is granted.

The device identifier is an identifier for identifying, for example, any one device included in the customer apparatus 1.

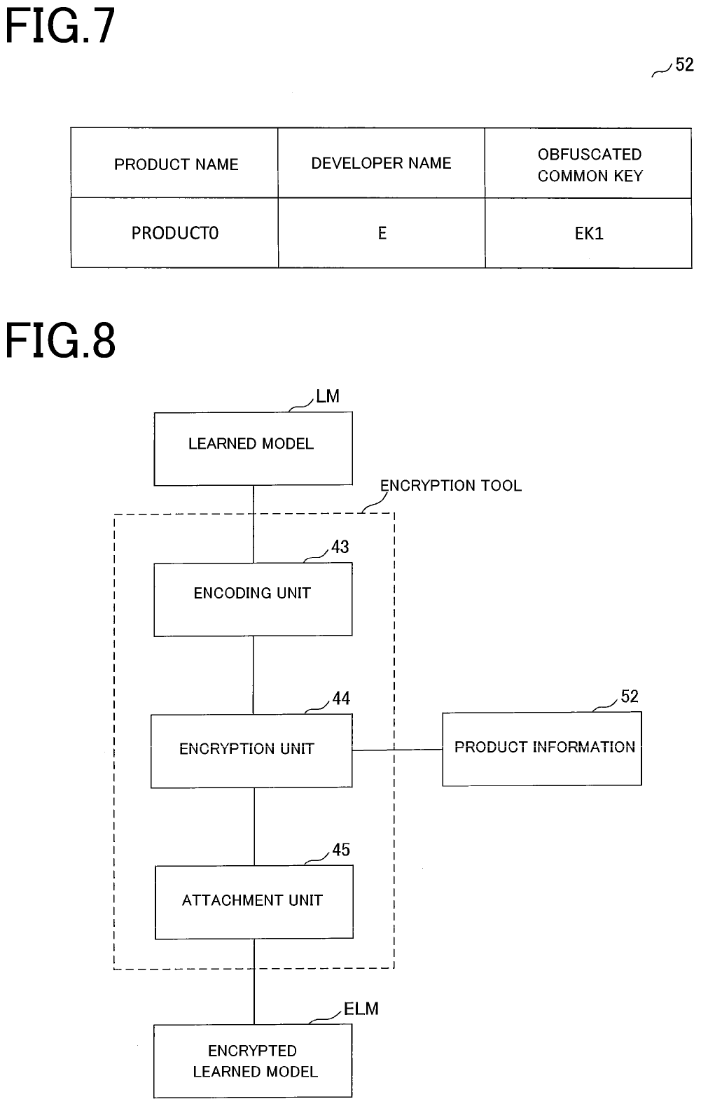

The product information 52 is information acquired from the management apparatus 3 by requesting the management apparatus 3 to register the product information 52, and for example, includes a product name, a developer name, and an obfuscated common key as illustrated in FIG. 7.

The product name is an identifier for identifying a learned model, for which registration of the product information 52 has been requested to the management apparatus 3.

The developer name is an identifier for identifying a developer who has requested registration of the product information 52.

The obfuscated common key is information generated by the management apparatus 3 by encrypting a common key, which is used for encryption processing and decryption processing of the learned model.

Descriptions are made with reference to FIG. 5.

The acquisition unit 41 acquires customer information including a product name, a customer name, an expiration date, and a device identifier from the customer apparatus 1 and stores the customer information in the customer management information 51. The acquisition unit 41 requests the management apparatus 3 to register the product information. The acquisition unit 41 acquires the product information 52 generated by the management apparatus 3 and memorizes the product information in the memory unit 50. The registration request of the product information includes a product name of a learned model and a developer name who has generated the learned model.

Further, the acquisition unit 41 transmits a generation request of the license information 21 to the management apparatus 3. The acquisition unit 41 acquires the license information generated by the management apparatus 3.

The learning unit 42 adjusts the weight of the neural network by using the network structure and learning parameters set by the developer. The learning parameters are, for example, hyperparameters for setting the number of units, load damping, sparse regularization, dropout, learning rate, optimizer, and the like, which are to be set at the time of performing deep learning using the framework.

The encoding unit 43 encodes a learned model including at least one of the network structure, the weight, and the bias. This enables the encoding unit 43 to generate an encoded learned model in which the learned model is encoded. The encoded learned model is an example of encoded data.

The encryption unit 44 encrypts the encoded learned model. This enables the encryption unit 44 to generate an encrypted learned model in which the encoded learned model is encrypted.

The attachment unit 45 attaches an encryption identifier for identifying that the learned model has been encrypted to the encrypted learned model in which the encoded learned model is encrypted. Further, when the learned model has not been encrypted, the attachment unit 45 attaches an encryption identifier for identifying that the learned model has not been encrypted to the learned model.

The attachment unit 45 may attach an encryption identifier, for example, to an encrypted network structure when a learned model includes the network structure, the weight, and the bias as separate pieces of data. Further, when a learned model includes the network structure, the weight, and the bias as separate pieces of data, the attachment unit 45 may attach an encryption identifier, for example, to the encrypted weight and bias.

The generation unit 46 generates the inference information 4a including the encrypted learned model, the inference DLL, and the application. The application is a program for performing various types of processing such as image recognition, speech recognition, and character recognition by using the result of inference processing using a learned model, and is created by a developer.

The output unit 47 outputs the inference information 4a to the storage apparatus 4. That is, the output unit 47 outputs an encrypted learned model in which an encoded learned model is encrypted. The output unit 47 may output the inference information 4a, for example, to a recording medium. In this case, a user may receive the recording medium from a developer, and read the inference information 4a from the recording medium, to acquire the inference information 4a by the acquisition unit 11.

Further, the output unit 47 outputs the license information 21 acquired from the management apparatus 3 to the customer apparatus 1.

FIG. 8 is an explanatory diagram of one mode of processing to be performed by the development apparatus according to the first embodiment.

The encryption processing performed by the development apparatus 2 is described in more detail with reference to FIG. 8. In the development apparatus 2, the control unit 40 executes an encryption tool to perform the encryption processing. The encryption tool is a program to be used, for example, when a developer encrypts a learned model, and is provided by the manager 3. The encryption tool functions as the encoding unit 43, the encryption unit 44, and the attachment unit 45 by being executed, for example, by the control unit 40.

When a learned model is generated by the learning unit 42, the acquisition unit 41 requests the management apparatus 3 to register the product information 52 corresponding to the learned model. The acquisition unit 42 acquires the product information 52 generated by the management apparatus 3 from the management apparatus 3, and memorizes the product information 52 in the memory unit 50.

After the product information 52 is memorized in the memory unit 50, the developer requests the development apparatus 2 to encrypt the learned model corresponding to a product name included in the product information 52. When encryption of the learned model is requested, the development apparatus 2 activates a cryptographic tool including the encoding unit 43, the encryption unit 44, and the attachment unit 45.

The encoding unit 43 encodes the learned model. The encoding unit 43 encodes, for example, at least one of the weight and the bias included in the learned model. At this time, the encoding unit 43 may use at least one of quantization and run-length encoding as an encoding algorithm.

The encryption unit 44 decrypts the obfuscated common key by performing an inverse operation to the operation used at the time of generating the obfuscated common key included in the product information 52. The encryption unit 44 encrypts the encoded learned model by using a common key. The attachment unit 45 attaches an encryption identifier for identifying that the learned model has been encrypted to the encrypted learned model. As described above, the development apparatus 2 generates the encrypted learned model in which the learned model is encrypted by performing the encryption processing. The encryption unit 44 may appropriately select and use Data Encryption Standard (DES), Advanced Encryption Standard (AES), or the like as the encryption algorithm.

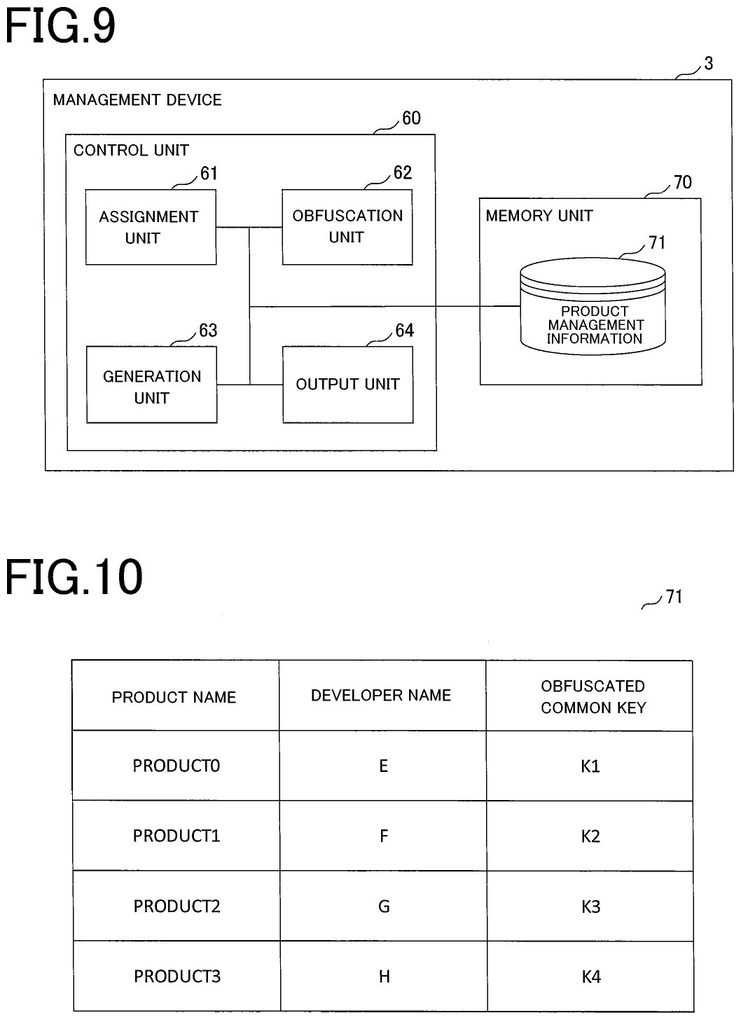

FIG. 9 is a functional block diagram illustrating one mode of the management apparatus according to the first embodiment.

Processing to be performed by the management apparatus 3 is described with reference to FIG. 9.

The management apparatus 3 includes a control unit 60 and a memory unit 70.

The control unit 60 includes an assignment unit 61, an obfuscation unit 62, a generation unit 63, and an output unit 64. The memory unit 70 memorizes therein product management information 71 in which a common key is assigned to a product name acquired from the development apparatus 2.

The product management information 71 is information indicating assignment of a common key to a product name of a learned model. The product management information 71 includes, for example, as illustrated in FIG. 10, a product name, a developer name, and an obfuscated common key.

The product name is an identifier for identifying a learned model, for which registration of the product information 52 is requested.

The developer name is an identifier for identifying a developer who requests registration of the product information 52.

The obfuscated common key is information in which a common key assigned to a learned model corresponding to a product name is obfuscated. The common key may be stored in the product management information 71 in a non-obfuscated state. In this case, the customer apparatus 1 may receive an unencrypted common key from the management apparatus 3 via the development apparatus 2, to decrypt the encrypted learned model. Further, the development apparatus 2 may receive an unencrypted common key from the management apparatus 3 to perform encryption of the learned model. In the following descriptions, it is assumed that the common key is stored in the product management information 71 in the obfuscated state. The common key is stored in the product management information 71 in an obfuscated state to prevent illegal use of the common key in a case where information stored in the product management information 71 is stolen by hacking the management apparatus 3 or the like.

Descriptions are made with reference to FIG. 9.

The assignment unit 61 assigns a common key to a product name and a developer name included in the registration request of the product information from the development apparatus 2.

The obfuscation unit 62 obfuscates the common key by performing a predetermined operation.

The generation unit 63 stores the product information 52, in which the product name, the developer name, and the obfuscated common key are associated with each other, in the product management information 71.

In response to an acquisition request of the product information 52 including the product name and the developer name from the development apparatus 2, the output unit 64 outputs the corresponding product information 52 to the development apparatus 2. The output unit 64 may output the product information 52, for example, to a recording medium. In this case, the developer may receive the recording medium from a manager, to acquire the product information 52 by causing the acquisition unit 42 to read the product information 52 from the recording medium.

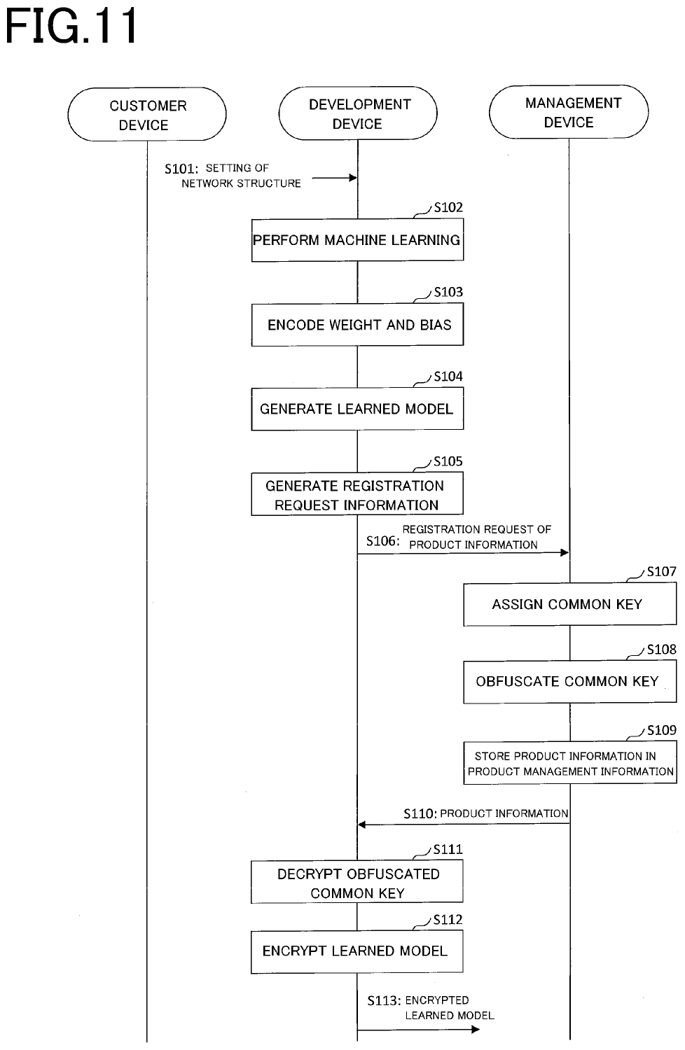

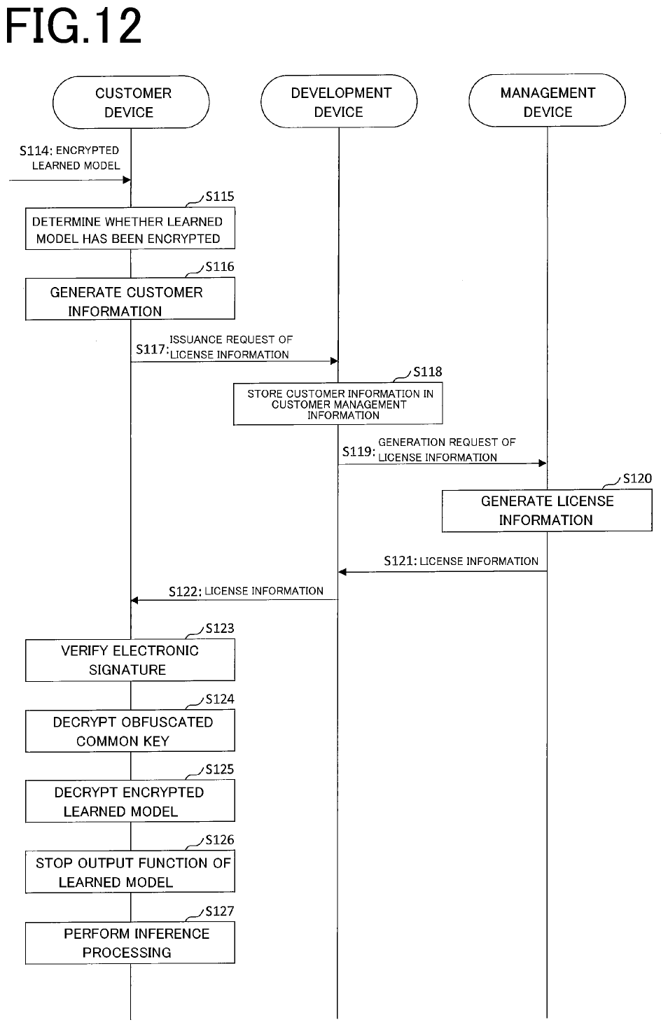

FIG. 11 and FIG. 12 are sequence diagrams illustrating an example of processing to be performed in the processing system according to the first embodiment.

Processing to be performed in the processing system according to the first embodiment is described with reference to FIG. 11 and FIG. 12. In the following descriptions, processing to be performed by the control unit 10 of the customer apparatus 1, by the control unit 40 of the development apparatus 2, and by the control unit 60 of the management apparatus 3 is described as the processing to be performed by the customer apparatus 1, the development apparatus 2, and the management apparatus 3, for simplifying the explanations.

Descriptions are made with reference to FIG. 11.

The development apparatus 2 receives an input of setting of a network structure of a neural network from a developer (S101). The development apparatus 2 adjusts the weight and the bias of an edge included in the neural network by performing machine learning (S102). Further, the development apparatus 2 encodes the adjusted weight and bias (S103). The development apparatus 2 then generates a learned model including the network structure and the encoded weight and bias (S104).

The development apparatus 2 generates registration request information of the product information 52 including a product name and a developer name of the learned model (S105). The development apparatus 2 requests the management apparatus 3 to register the product information 52 by transmitting the registration request information to the management apparatus 3 (S106).

Upon reception of the registration request information from the development apparatus 2, the management apparatus 3 generates a common key and assigns the common key to the product name and the developer name included in the registration request information (S107). Further, the management apparatus 3 obfuscates the common key assigned to the product name and the developer name (S108). The management apparatus 3 generates the product information 52 in which the product name, the developer name, and the obfuscated common key are associated with each other and stores the product information 52 in the product management information 71 (S109). The management apparatus 3 transmits the generated product information 52 to the development apparatus 2 (S110).

The development apparatus 2 decrypts the obfuscated common key included in the product information 52, upon reception of the product information 52 from the management apparatus 3 (S111). The development apparatus 2 uses the decrypted common key to encrypt a learned model corresponding to the product name included in the product information 52 (S112). The development apparatus 2 transmits the encrypted learned model to the storage apparatus 4 to store the encrypted learned model in the storage apparatus 4 (S113). At this time, the development apparatus 2 may generate inference information 4a including the encrypted learned model, the application, and the inference DLL and store the inference information in the storage apparatus 4.

Descriptions are made with reference to FIG. 12.

The customer apparatus 1 acquires the learned model from the storage apparatus 4 in response to a request from a user (S114). At this time, the customer apparatus 1 may acquire the learned model included in the inference information 4a by acquiring the inference information including the encrypted learned model, application, and inference DLL from the storage apparatus 4.

The customer apparatus 1 determines whether the acquired learned model has been encrypted (S115). The customer apparatus 1 performs inference processing by using the learned model, when the acquired learned model has not been encrypted.

When the acquired learned model has been encrypted, the customer apparatus 1 generates customer information including a product name, a customer name, an expiration date, and a device identifier (S116). The customer apparatus 1 transmits an issuance request of license information 21 including the generated customer information to the development apparatus 2 (S117).

Upon reception of the issuance request of the license information 21, the development apparatus 2 stores the customer information included in the issuance request of the license information 21 in the customer management information 51 (S118). The development apparatus 2 transmits a generation request of the license information 21 including the customer information to the management apparatus 3 (S119).

Upon reception of the generation request of the license information 21, the management apparatus 3 extracts a record corresponding to the product name included in the customer information from the product management information 71, and generates an electronic signature by using the customer information included in the issuance request of the license information 21. Further, the management apparatus 3 generates the license information 21 including the obfuscated common key included in the extracted record, the generated electronic signature, and the received customer information (S120). Next, the management apparatus 3 transmits the generated license information 21 to the development apparatus 2 (S121).

Upon reception of the license information 21 from the management apparatus 3, the development apparatus 2 transmits the license information 21 to the customer apparatus 1 (S122).

Upon reception of the license information 21 from the development apparatus 2, the customer apparatus 1 verifies the electronic signature included in the license information 21 (S123). When the electronic signature cannot be authorized, the customer apparatus 1 ends the process.

When the electronic signature is authorized, the customer apparatus 1 decrypts the obfuscated common key (S124). Further, the customer apparatus 1 decrypts the encrypted learned model by using the decrypted common key (S125). Further, the customer apparatus 1 stops the function of outputting the information on the encrypted learned model (S126). The customer apparatus 1 then performs inference processing (S127).

As described above, the customer apparatus 1 according to the first embodiment determines whether the acquired learned model has been encrypted. When the learned model has been encrypted, the customer apparatus 1 automatically decrypts the learned model, and performs inference processing using the decrypted learned model. Therefore, because the customer apparatus 1 performs the inference processing without outputting the decrypted learned model, the customer apparatus 1 can prevent leakage of the network structure and the weight included in the learned model.

The customer apparatus 1 according to the first embodiment stops the process to output the learned model, being a part of the function of the framework, when the encrypted learned model is input. Accordingly, leakage of the network structure and the weight included in the learned model can be prevented.

The learned model according to the first embodiment includes an encryption identifier for identifying whether the learned model has been encrypted in the information on the network structure or the weight. This enables the customer apparatus 1 to determine whether the learned model has been encrypted, automatically decrypt the learned model, and perform inference processing using the decrypted learned model. Therefore, because the customer apparatus 1 performs the inference processing without outputting the decrypted learned model, the customer apparatus 1 can prevent leakage of the network structure and the weight included in the learned model.

Since the customer apparatus 1 according to the first embodiment acquires the license information 21 and decrypts the encrypted learned model according to the license information 21 and uses the learned model, the customer apparatus 1 can reject the use of the learned model by a user who does not hold the license information 21. Therefore, the customer apparatus 1 can prevent illegal use of the learned model.

The development apparatus 2 according to the first embodiment encodes the weight and the bias adjusted by learning and then encrypts the weight and the bias, to generate an encrypted learned model. That is, the development apparatus 2 performs the encryption processing after reducing the size of the learned model to be encrypted. Therefore, the development apparatus 2 can reduce the load of the encryption processing and the size of the encrypted learned model.

The development apparatus 2 according to the first embodiment generates an encrypted learned model including an encryption identifier for identifying whether the learned model has been encrypted in the information on the network structure or the weight. Further, according to the first embodiment, the functions of the framework executed by the customer apparatus 1 include a function of determining whether the learned model has been encrypted by referring to the encryption identifier and a function of decrypting the encrypted learned model. This enables the customer apparatus 1 to determine whether the learned model has been encrypted by referring to the encryption identifier. Therefore, when the learned model read into the framework has been encrypted, the customer apparatus 1 can automatically decrypt the learned model, and can prevent leakage of the network structure and the weight included in the learned model.

The license information 21 according to the first embodiment includes information in which a common key is obfuscated by using at least one of the product name, the customer name, the expiration date, and the device identifier. Accordingly, the processing system 200 according to the first embodiment makes it difficult to use the common key even if the license information 21 is stolen, thereby enabling to prevent illegal use of the learned model, and leakage of the network structure and the weight.

The license information 21 according to the first embodiment includes the expiration date. Accordingly, the customer apparatus 1 rejects the use of the encrypted learned model, when the expiration date has passed. Therefore, the customer apparatus 1 can set a period during which a learned model can be used, for example, at the time of providing the learned model to a user as an evaluation version.

The electronic signature according to the first embodiment is generated by using at least one of the product name, the customer name, the expiration date, and the device identifier included in the license information 21. Accordingly, if information included in the license information 21 is rewritten, the customer apparatus 1 determines that the license information 21 has been illegally falsified, and can reject the use of the encrypted learned model.

In the processing system 200 according to the first embodiment, it has been described that a developer of a learned model creates an application that uses the learned model. However, the application may be created by an application developer different from the developer of the learned model. In this case, the license information 21 and the encrypted learned model may be provided from the developer of the learned model to a customer via an application developer.

Even in a case in which the license information 21 and an encrypted learned model are provided to a customer via the application developer, decryption of an obfuscated common key is automatically performed by performing an inverse operation to the operation used at the time of generating the obfuscated common key in the inference DLL. That is, the application developer develops the application and the customer uses the application without knowing the contents of the learned model. Accordingly, in the processing system 200, the contents of the learned model are used without being known by a person other than the developer of the learned model. Therefore, the processing system 200 can promote collaboration between the developer of the learned model and the application developer, while reducing the risk such that the learned model is misused without permission.

### Second Embodiment

A processing system according to a second embodiment is described.

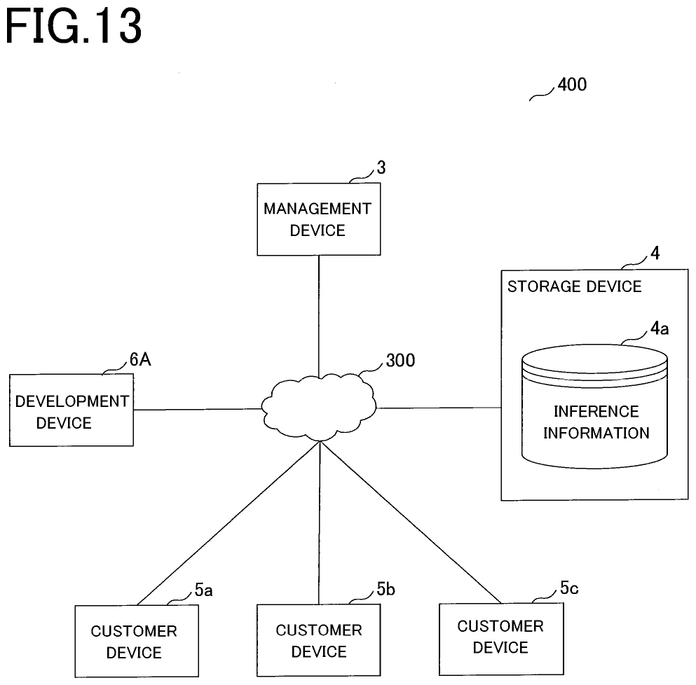

FIG. 13 is a diagram illustrating an example of a processing system using a neural network according to the second embodiment.

An outline of the processing using a neural network is described with reference to FIG. 13.

A configuration of a processing system 400 according to the second embodiment is the same as that of the processing system 200 according to the first embodiment described with reference to FIG. 1, and thus descriptions thereof are omitted. In the following descriptions, configurations of customer apparatuses 5a, 5b , and 5c and a configuration of a development apparatus 6A in the processing system 400, which each have different functions from those of the processing system 200, are described. Same configurations as those of the processing system 200 are each denoted by a like reference sign as that of the first embodiment and explanations thereof are omitted. The customer apparatus 5a, the customer apparatus 5b, and the customer apparatus 5c are also simply referred to as “customer apparatus 5A”, when these apparatuses are not particularly distinguished from each other.

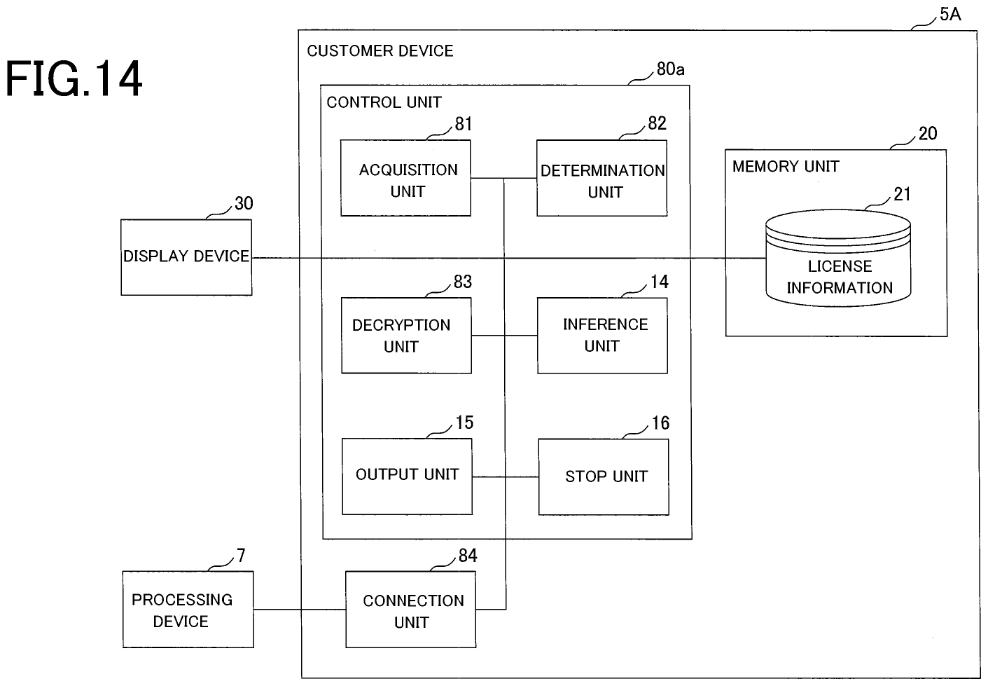

FIG. 14 is a functional block diagram illustrating one mode of the customer apparatus according to the second embodiment.

Processing to be performed by the customer apparatus 5A is described with reference to FIG. 14.

The customer apparatus 5A includes a control unit 80a, the memory unit 20, and a connection unit 84. The configuration of the customer apparatus 5A is such that the connection unit 84 is added to the configuration of the customer apparatus 1 according to the first embodiment. In the following descriptions, the connection unit 84, and changed functions of an acquisition unit 81, a determination unit 82, and a decryption unit 83, whose functions are partly changed with the addition of the connection unit 84, are described, and descriptions of other elements are omitted.

The connection unit 84 is detachably connected to a processing apparatus 7 in which the license information 21 is stored. The processing apparatus 7 is an apparatus in which the license information 21 is stored by the development apparatus 6A, and is, for example, a USB dongle including a control circuit, a memory apparatus, and an input/output interface.

The acquisition unit 81 requests the development apparatus 6A to issue the license information 21 in response to a request from a user. Accordingly, the processing apparatus 7 in which the license information 21 is stored by the development apparatus 6A is provided to the user from a developer. Further, the acquisition unit 81 acquires the license information 21 from the processing apparatus 7, when the processing apparatus 7 is connected to the connection unit 84.

The determination unit 82 and the decryption unit 83 each perform a determination process and a decryption process by using the license information 21 stored in the processing apparatus 7.

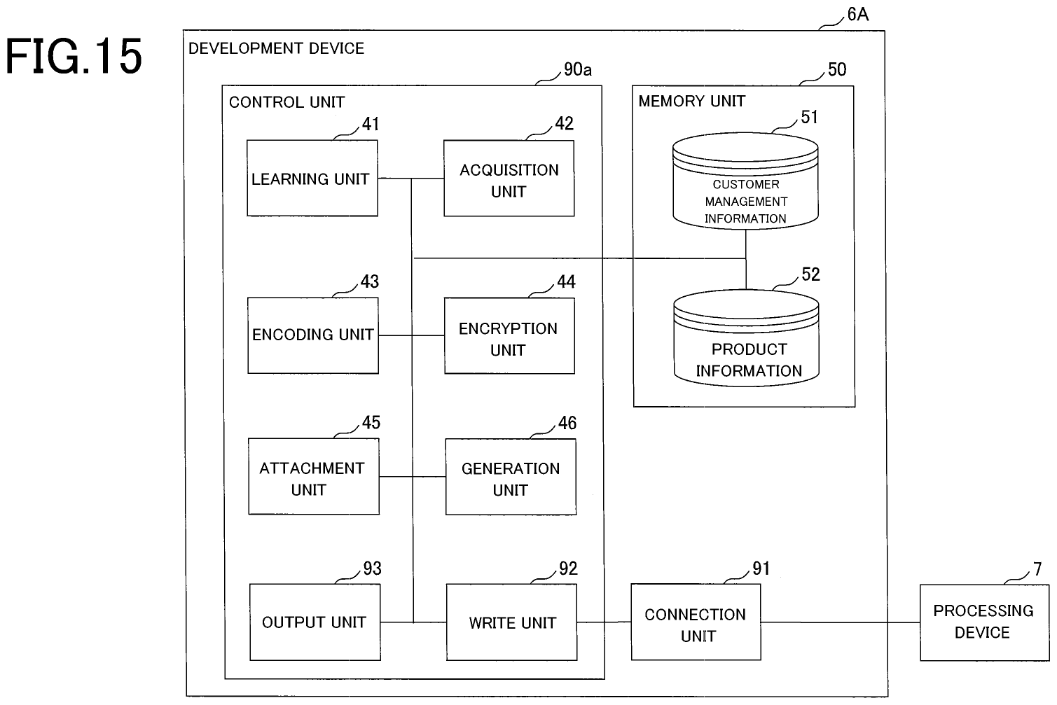

FIG. 15 is a functional block diagram illustrating one mode of the development apparatus according to the second embodiment.

Processing to be performed by the development apparatus 6A is described with reference to FIG. 15.

The development apparatus 6A includes a control unit 90a, the memory unit 50, and a connection unit 91.

The development apparatus 6A has a configuration in which a write unit 92 and the connection unit 91 are added to the configuration of the development apparatus 2 according to the first embodiment. In the following descriptions, the connection unit 91, the write unit 92, and a changed function of an output unit 93, whose function is partly changed, are described, and descriptions of other elements are omitted.

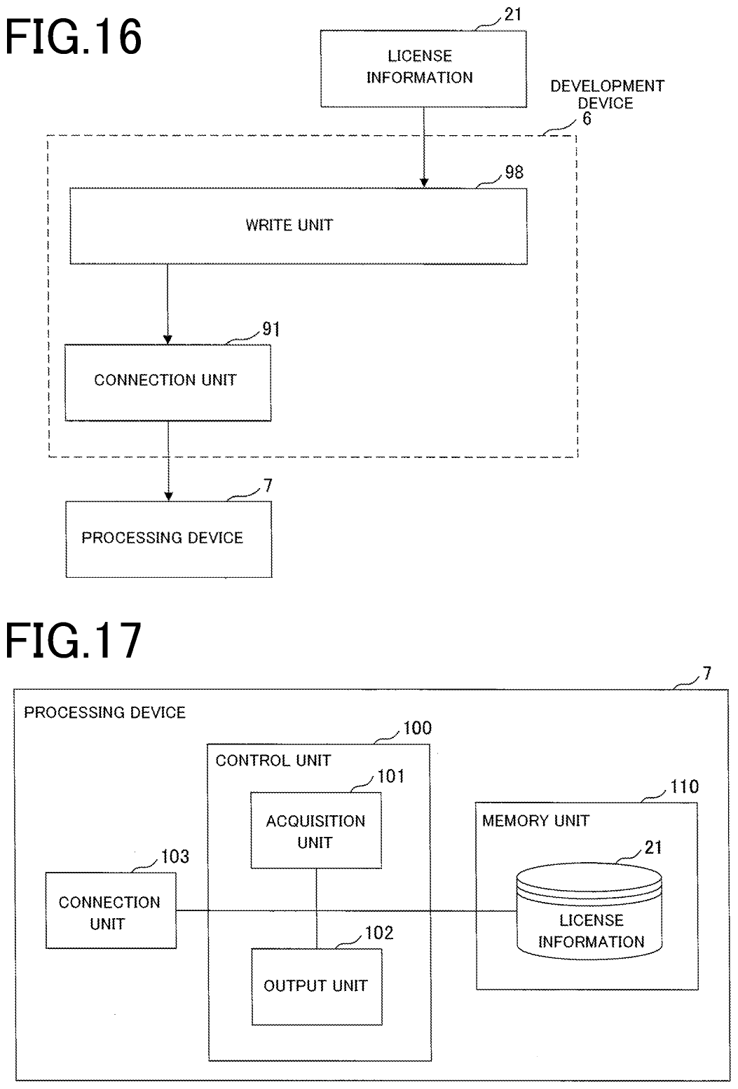

The connection unit 91 is detachably connected to the processing apparatus 7. As illustrated in FIG. 16, the write unit 92 writes the license information 21 acquired from the management apparatus 3 in the processing apparatus 7 via the connection unit 91. In the second embodiment, the output unit 93 may not output the license information 21 acquired from the management apparatus 3 to the customer apparatus 5A.

FIG. 17 is a functional block diagram illustrating one mode of the processing apparatus according to the second embodiment.

Processing to be performed by the processing apparatus 7 is described with reference to FIG. 17.

The processing apparatus 7 includes a control unit 100, a memory unit 110, and a connection unit 103. The control unit 100 includes an acquisition unit 101 and an output unit 102. The memory unit 110 memorizes therein the license information 21.

The connection unit 103 is detachably connected to the customer apparatus 5A and the development apparatus 6A. The acquisition unit 101 acquires the license information 21 from the development apparatus 6A via the connection unit 103, when the connection unit 103 is connected to the development apparatus 6A, and memorizes the license information 21 in the memory unit 110. The output unit 102 outputs the license information 21 to the customer apparatus 5A via the connection unit 103, when the connection unit 103 is connected to the customer apparatus 5A.

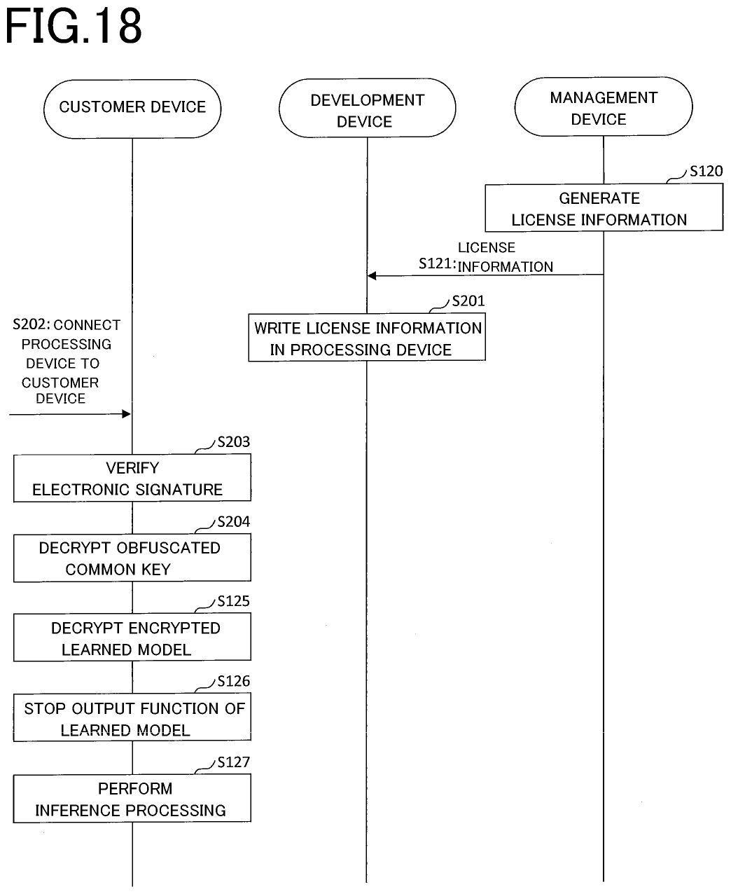

FIG. 18 is a sequence diagram illustrating an example of processing to be performed in the processing system according to the second embodiment.

The processing to be performed in the processing system according to the second embodiment is described with reference to FIG. 18. In the following descriptions, processing performed by the control unit 80a of the customer apparatus 5A, the control unit 90 a of the development apparatus 6A, and the control unit 60 of the management apparatus 3 is described as the processing performed by the customer apparatus 5A, the development apparatus 6A, and the management apparatus 3, for simplifying the explanations.

In the processing performed by the processing system 400 according to the second embodiment, processes at S201 to S204 described below are added, instead of processes at S122 to S124 performed by the processing system 200 according to the first embodiment. In the following descriptions, processes from S201 to S204 are described, and descriptions of other processes are omitted.

At S122, upon reception of the license information 21 from the management apparatus 3, the development apparatus 6A writes the license information 21 in the processing apparatus 7 (S201). A developer provides the processing apparatus 7 to a user.

Upon connection of the processing apparatus 7 to the customer apparatus 5A by the user (S202), the customer apparatus 5A acquires the license information 21 from the processing apparatus 7 and verifies an electronic signature included in the acquired license information 21 (S203). When the electronic signature cannot be authorized, the customer apparatus 5A ends the process.

When having authorized the electronic signature, the customer apparatus 5A decrypts the obfuscated common key included in the license information 21 acquired from the processing apparatus 7 (S204). The customer apparatus 5A uses the decrypted common key to decrypt an encrypted learned model (S125). Decryption of the obfuscated common key may be performed by the customer apparatus 5A by performing an inverse operation to the operation used at the time of generating the obfuscated common key in the management apparatus 3, by using the inference DLL included in the inference information 4a.

As described above, the customer apparatus 5A according to the second embodiment makes it possible to decrypt a learned model only by a user who is provided with the processing apparatus 7, since the encrypted learned model is decrypted by using the license information 21 stored in the processing apparatus 7. Therefore, the customer apparatus 5A can prevent leakage of the network structure and the weight included in the learned model.

In the processing system 400 according to the second embodiment, it has been described that a developer of a learned model creates an application that uses the learned model. However, the application may be created by an application developer different from the developer of the learned model. In this case, the encrypted learned model may be provided from the developer of the learned model to a customer via the application developer.

Also in a case where the encrypted learned model is provided to a customer via the application developer, decryption of an obfuscated common key is automatically performed by performing an inverse operation to the operation used at the time of generating the obfuscated common key in the inference DLL. That is, the application developer develops the application and the customer uses the application without knowing the contents of the learned model. Accordingly, in the processing system 400, the contents of the learned model are used without being known by a person other than the developer of the learned model. Therefore, the processing system 400 can promote collaboration between the developer of the learned model and the application developer, while reducing the risk such that the learned model is misused without permission.

### Third Embodiment

A processing system according to a third embodiment is described.

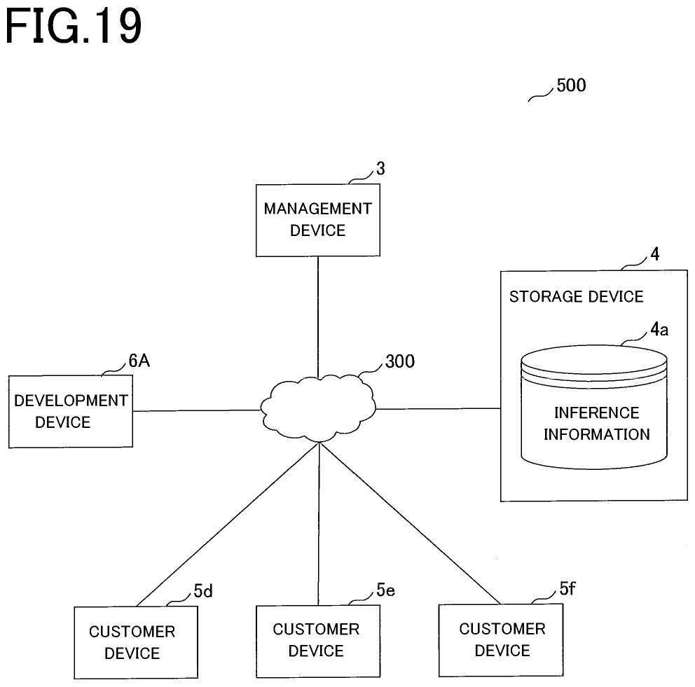

FIG. 19 is a diagram illustrating an example of a processing system using a neural network according to the third embodiment.

An outline of the processing using a neural network is described with reference to FIG. 19.

A configuration of a processing system 500 according to the third embodiment is the same as that of the processing system 400 according to the second embodiment described with reference to FIG. 13, and thus descriptions thereof are omitted. In the following descriptions, configurations of customer apparatuses 5d, 5e, and 5f and a configuration of a processing apparatus 9 in the processing system 500, which each have different functions from those of the processing system 400, are described. Same configurations as those of the processing system 400 are each denoted by a like reference sign as that of the second embodiment and explanations thereof are omitted. The customer apparatus 5d, the customer apparatus 5e, and the customer apparatus 5f are also simply referred to as “customer apparatus 5B”, when these apparatuses are not particularly distinguished from each other.

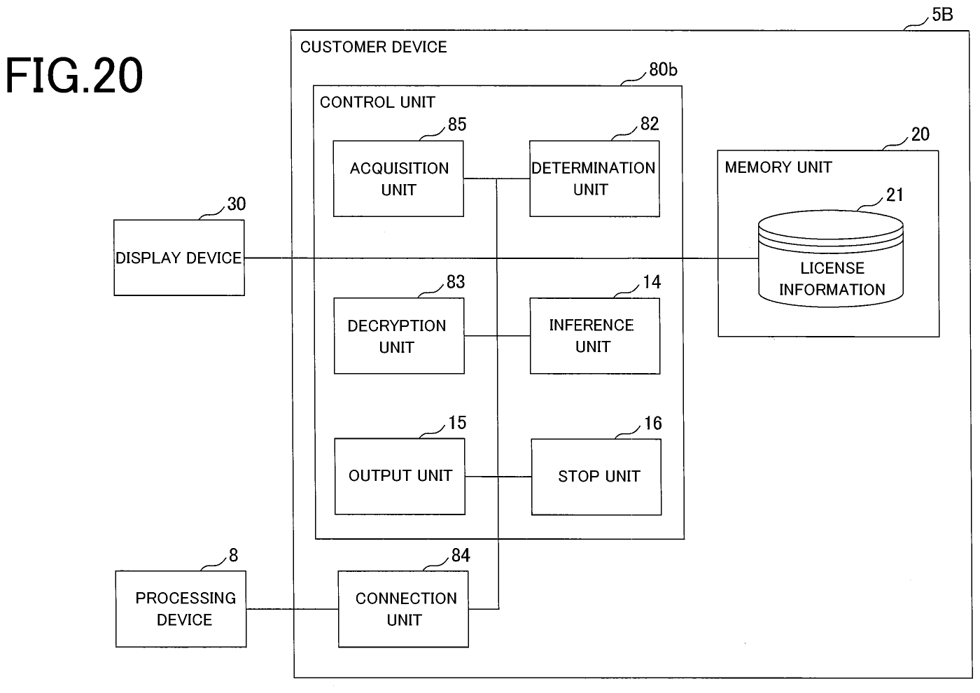

FIG. 20 is a functional block diagram illustrating one mode of the customer apparatus according to the third embodiment.

Processing to be performed by the customer apparatus 5B is described with reference to FIG. 20.

The customer apparatus 5B includes a control unit 80b, the memory unit 20, and the connection unit 84. In the following descriptions, with a changed function of the acquisition unit 85, whose function is partly changed, is described, and descriptions of other elements are omitted.

The connection unit 84 has a function of decrypting an encrypted learned model, and is detachably connected to a processing apparatus 8 in which the license information 21 is stored. The processing apparatus 8 is an apparatus in which the license information 21 is stored by the development apparatus 6, and is, for example, a USB dongle including a control circuit, a memory apparatus, and an input/output interface.

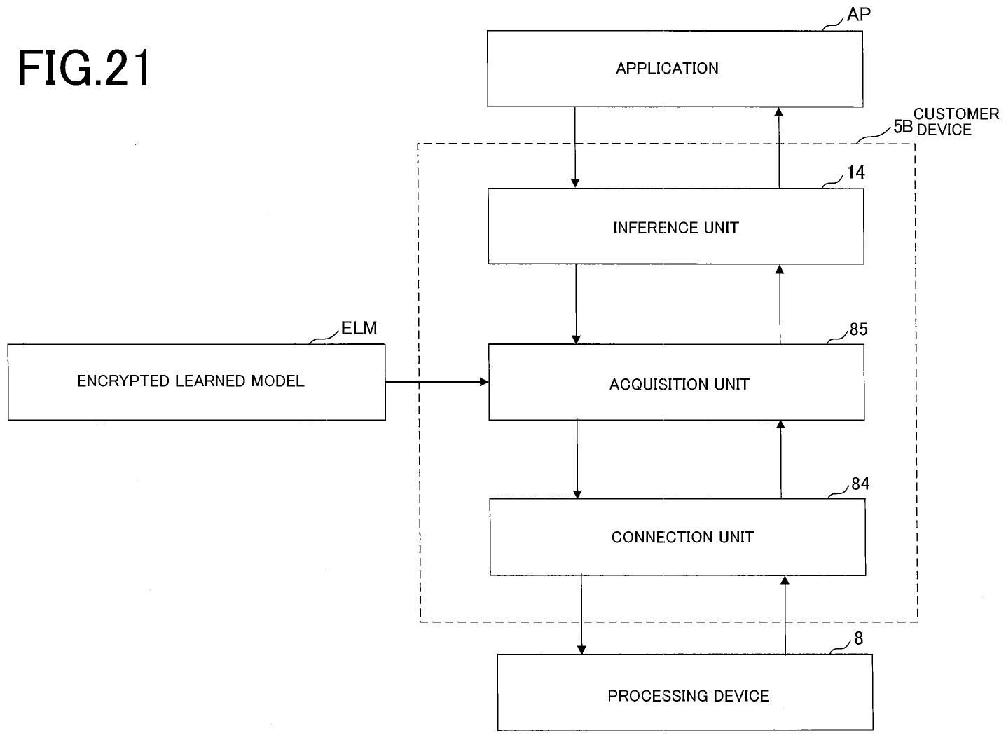

As illustrated in FIG. 21, upon input of an encrypted learned model, when the processing apparatus 8 is connected to the connection unit 84, the acquisition unit 85 acquires the learned model by causing the processing apparatus 8 to decrypt the encrypted learned model.

The inference unit 14 uses the decrypted learned model, to perform inference processing by using target data to be inferred, which is input from the application.

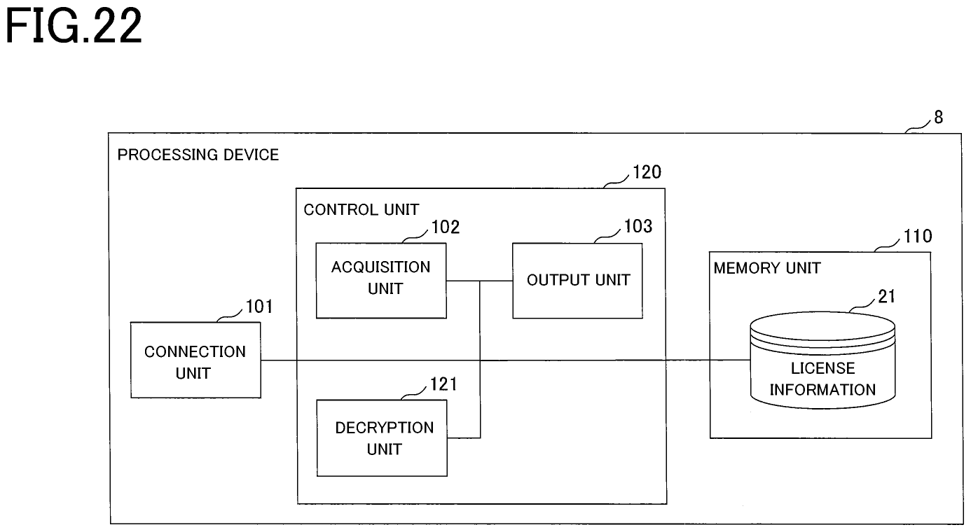

FIG. 22 is a functional block diagram illustrating one mode of the processing apparatus according to the third embodiment.

Processing to be performed by the processing apparatus 8 is described with reference to FIG. 22.

The processing apparatus 8 according to the third embodiment includes a control unit 120, the memory unit 110, and the connection unit 101. The processing apparatus 8 has a configuration in which a decryption unit 121 is added to the configuration of the processing apparatus 7 according to the second embodiment. In the following descriptions, the decryption unit 121 is described and descriptions of other elements are omitted. The processing apparatus 8 may include a determination unit that determines whether an encrypted learned model input from the customer apparatus 5B has been encrypted by referring to an encryption identifier.

When an encrypted learned model is input via the customer apparatus 5B, the decryption unit 121 decrypts an obfuscated common key included in the license information 21. Further, the decryption unit 121 decrypts the encrypted learned model by using the decrypted common key. The output unit 103 outputs the encrypted learned model, which has been decrypted, to the customer apparatus 5B via the connection unit 101.

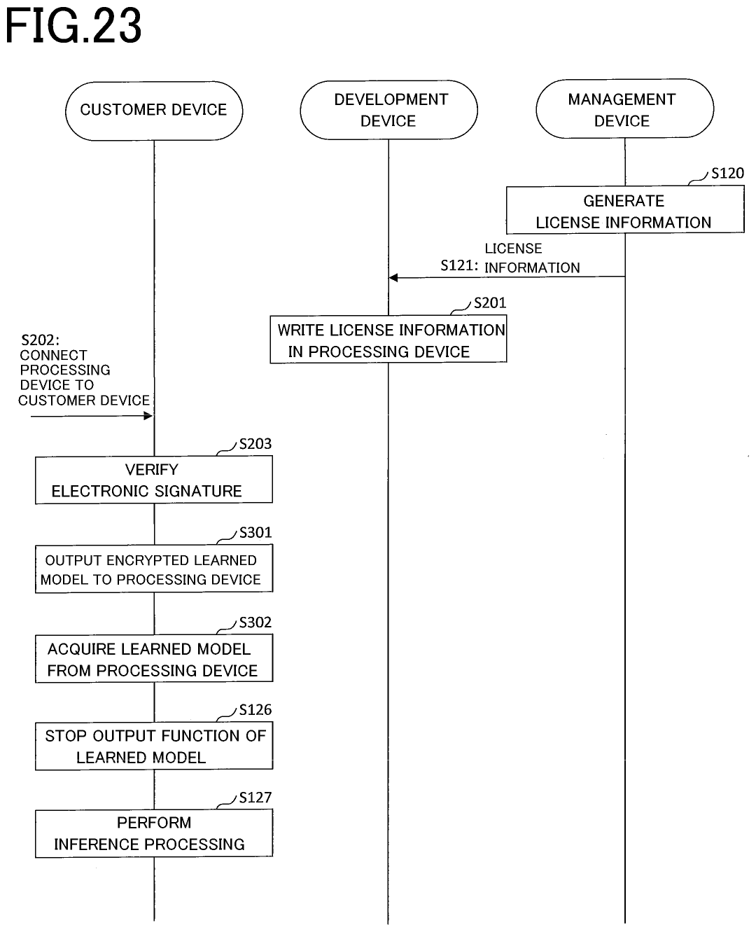

FIG. 23 is a sequence diagram illustrating an example of processing to be performed in the processing system according to the third embodiment.

Processing to be performed in the processing system 500 according to the third embodiment is described with reference to FIG. 23. In the following descriptions, processing to be performed by the control unit 80b of the customer apparatus 5B, the control unit 90a of the development apparatus 6A, and the control unit 60 of the management apparatus 3 is described as the processing to be performed by the customer apparatus 5B, the development apparatus 6A, and the management apparatus 3, for simplifying the explanations.

In the processing performed by the processing system 500 according to the third embodiment, processes at S301 and S302 described below are added, instead of processes at S204 and S125 performed by the processing system 400 according to the second embodiment. In the following descriptions, processes at S301 and S302 are described, and descriptions of other processes are omitted.

When the processing apparatus 8 is connected, for example, by a user (S202), the customer apparatus 5B acquires the license information 21 from the processing apparatus 8 and verifies an electronic signature included in the acquired license information 21 (S203). When the electronic signature cannot be authorized, the customer apparatus 5B ends the process.

When the electronic signature is authorized, the customer apparatus 5B outputs an encrypted learned model to the processing apparatus 8 (S301). Accordingly, the customer apparatus 5B causes the processing apparatus 8 to decrypt the encrypted learned model. The customer apparatus 5B acquires the decrypted learned model from the processing apparatus 8 (S302).

As described above, since the customer apparatus 5B according to the third embodiment causes the processing apparatus 8 to decrypt the encrypted learned model, only a user who is provided with the processing apparatus 8 can decrypt the learned model. Therefore, the customer apparatus 5B can prevent leakage of the network structure and the weight included in the learned model.

In the processing system 500 according to the third embodiment, it has been described that the developer of the learned model creates an application that uses the learned model. However, the application may be created by an application developer different from the developer of the learned model. In this case, the encrypted learned model may be provided from the developer of the learned model to a customer via the application developer.

Also in a case where the encrypted learned model is provided to a customer via the application developer, decryption of an obfuscated common key is automatically performed by performing an inverse operation to the operation used at the time of generating the obfuscated common key in the inference DLL. That is, the application developer develops the application and the customer uses the application without knowing the contents of the learned model. Accordingly, in the processing system 500, the contents of the learned model are used without being known by a person other than the developer of the learned model. Therefore, the processing system 500 can promote collaboration between the developer of the learned model and the application developer, while reducing the risk such that the learned model is misused without permission.

### Fourth Embodiment

A processing system according to a fourth embodiment is described.

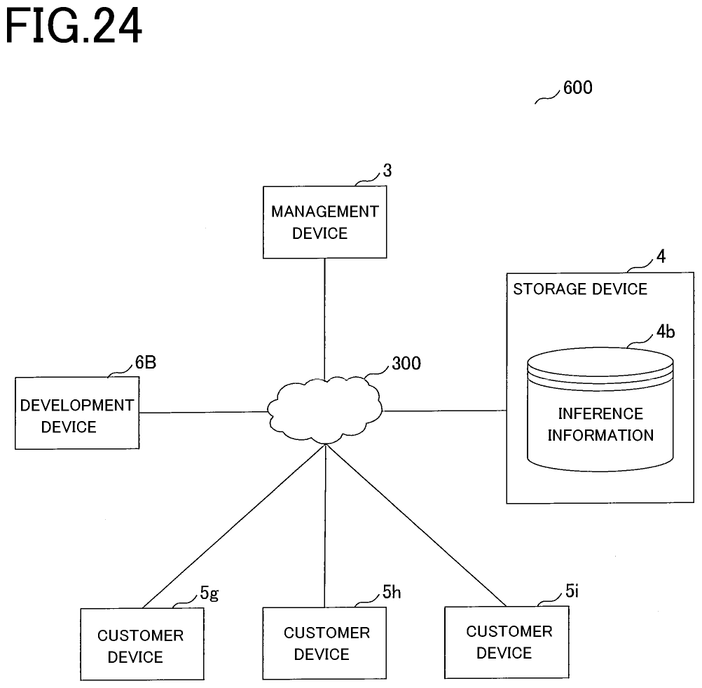

FIG. 24 is a diagram illustrating an example of a processing system using a neural network according to the fourth embodiment.

An outline of the processing using a neural network is described with reference to FIG. 24.

A configuration of a processing system 600 according to the fourth embodiment is the same as that of the processing system 500 according to the third embodiment described with reference to FIG. 19, and thus descriptions thereof are omitted. In the following descriptions, in the processing system 600, configurations of customer apparatuses 5g, 5h, and 5i, a configuration of a development apparatus 6B, and a configuration of a processing apparatus 9, which each have different functions from those of the processing system 500, are described. Same configurations as those of the processing system 500 are each denoted by a like reference sign as that of the third embodiment and explanations thereof are omitted. The customer apparatus 5g, the customer apparatus 5h, and the customer apparatus 5i are also simply referred to as “customer apparatus 5C”, when these apparatuses are not particularly distinguished from each other.

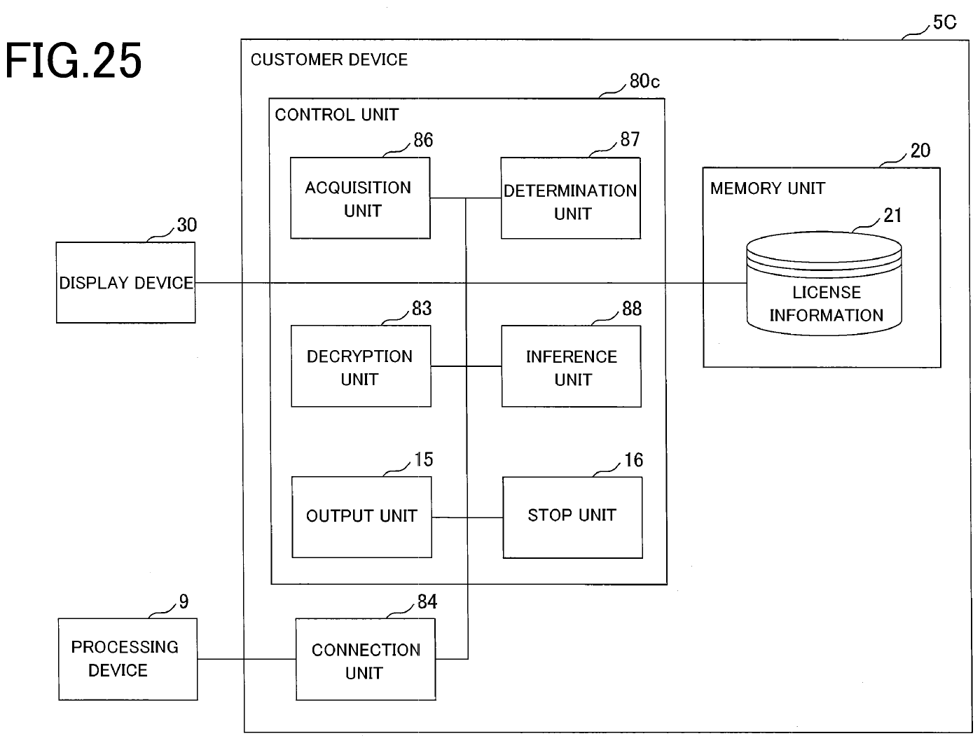

FIG. 25 is a functional block diagram illustrating one mode of the customer apparatus according to the fourth embodiment.

Processing to be performed by the customer apparatus 5C is described with reference to FIG. 25.

The customer apparatus 5C includes the control unit 80b, the memory unit 20, and the connection unit 84. In the following descriptions, changed functions of an acquisition unit 86, a determination unit 87, and an inference unit 88, whose functions are partly changed, are described, and descriptions of other elements are omitted.

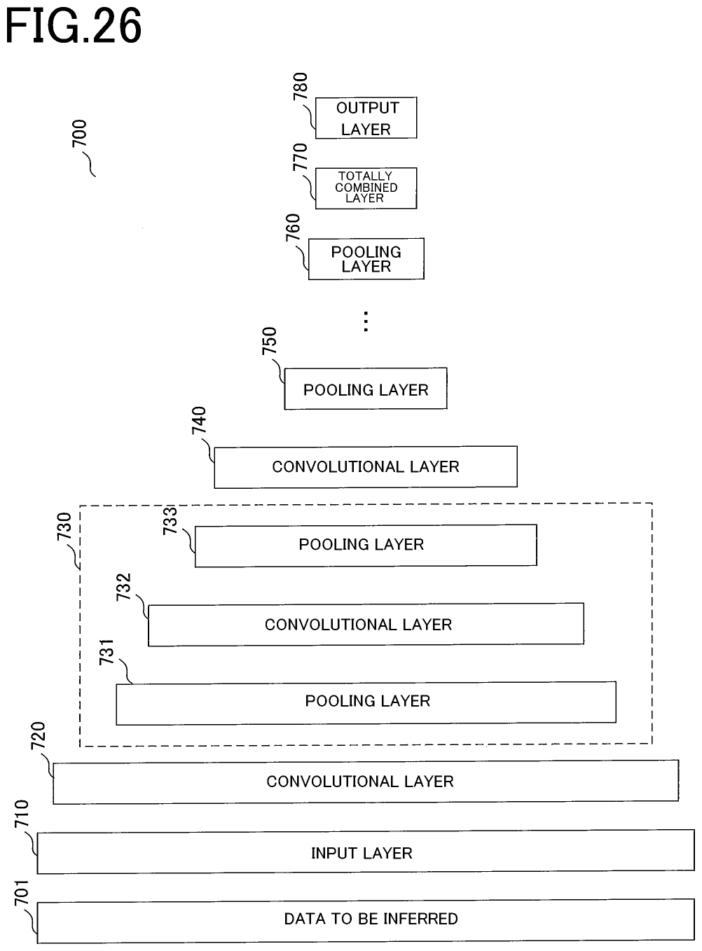

The connection unit 84 has a function of performing an operation (second operation described later) in a part of layers belonging to the neural network and a function of decrypting an encrypted learned model, and is detachably connected to the processing apparatus 9 in which the license information 21 and layer information 141 are stored. The layer information 141 is information including the network structure, the weight, and the bias of a layer 730 including three or more continuous layers included in a convolutional neural network 700, for example, illustrated in FIG. 26.

The layer information 141 described above is only an example, and may be arbitrary one or more layers included in the convolutional neural network or other neural networks. In the following descriptions, the structure of the neural network is described as the convolutional neural network illustrated in FIG. 26.

The acquisition unit 86 acquires an encrypted learned model excluding the layer information 141 from the storage apparatus 4. The determination unit 87 determines whether the encrypted learned model excluding the layer information 141 has been input. The encrypted learned model excluding the layer information 141 is, for example, information in which information indicating the network structure, the weight, and the bias of the layer 730 illustrated in FIG. 26 is excluded from a learned model of the convolutional neural network 700.

That is, the encrypted learned model excluding the layer information 141 is information obtained by encrypting a first learned model including the structure and the weight of a first operation of a neural network that includes a first operation including one or more layers and a second operation including one or more other layers. The first operation is an operation corresponding to the network structure, the weight, and the bias included in an input layer 710 to which data 701 to be inferred is input from an application, a convolutional layer 720, and from a convolutional layer 740 to an output layer 780. The second operation is an operation corresponding to the network structure, the weight, and the bias included in the layer 730 that includes from a pooling layer 731 to a pooling layer 733, for example, illustrated in FIG. 26.

When the encrypted learned model excluding the layer information 141 is input, the acquisition unit 86 outputs the encrypted learned model excluding the layer information 141 to the processing apparatus 9. Accordingly, the acquisition unit 86 causes the processing apparatus 9 to decrypt the encrypted learned model excluding the layer information 141.

The acquisition unit 86 acquires a learned model excluding the layer information 141 from the processing apparatus 9. The inference unit 88 performs processing up to the convolutional layer 720 illustrated in FIG. 26 by using the learned model excluding the layer information 141. The acquisition unit 86 outputs output data of the convolutional layer 720 to the processing apparatus 9. Accordingly, the acquisition unit 86 causes the processing apparatus 9 to perform the second operation by using the layer information 141. In the following descriptions, the second operation using the layer information 141 is also referred to as “operation of the layer information 141”.

The acquisition unit 86 acquires an operation result of the layer information 141 from the processing apparatus 9. The inference unit 88 performs an operation corresponding to layers from the convolutional layer 730 to the output layer 780 illustrated in FIG. 26 by using the operation result of the layer information 141.

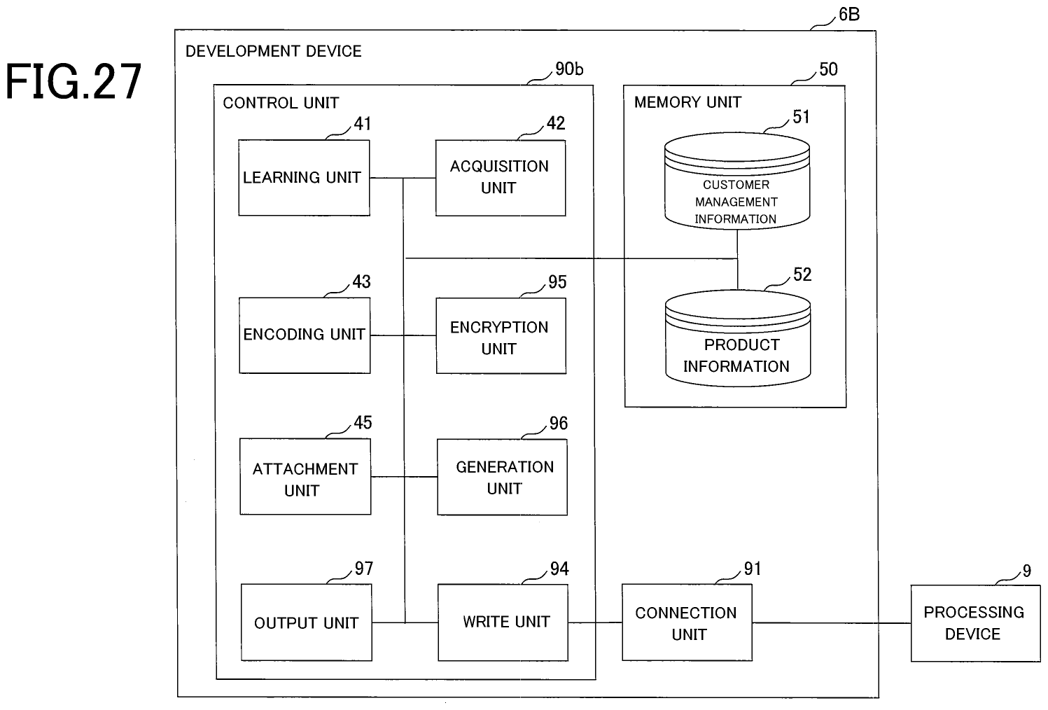

FIG. 27 is a functional block diagram illustrating one mode of the development apparatus according to the fourth embodiment.

Processing to be performed by the development apparatus 6B is described with reference to FIG. 27.

The development apparatus 6B includes a control unit 90b, the memory unit 50, and a connection unit 99. In the following descriptions, changed functions of a write unit 94, an encryption unit 95, a generation unit 96, and an output unit 97, whose functions are partly changed, are described, and descriptions of other elements are omitted.

The connection unit 91 is detachably connected to the processing apparatus 9. The write unit 94 writes the layer information 141, which is a part of a learned model generated by the learning unit 42 and the encoding unit 43, in the processing apparatus 9 via the connection unit 91. In the fourth embodiment, the encryption unit 95 encrypts a learned model excluding the layer information 141. The generation unit 96 generates inference information 4b including an encrypted learned model excluding the layer information 141, the inference DLL, and an application. The output unit 97 outputs the inference information 4b to the storage apparatus 4. The encryption unit 95 may encrypt the layer information 141, and the write unit 94 may write the encrypted layer information 141 in the processing apparatus 9. Further, the output unit 97 may output the inference information 4b to the storage apparatus 4.

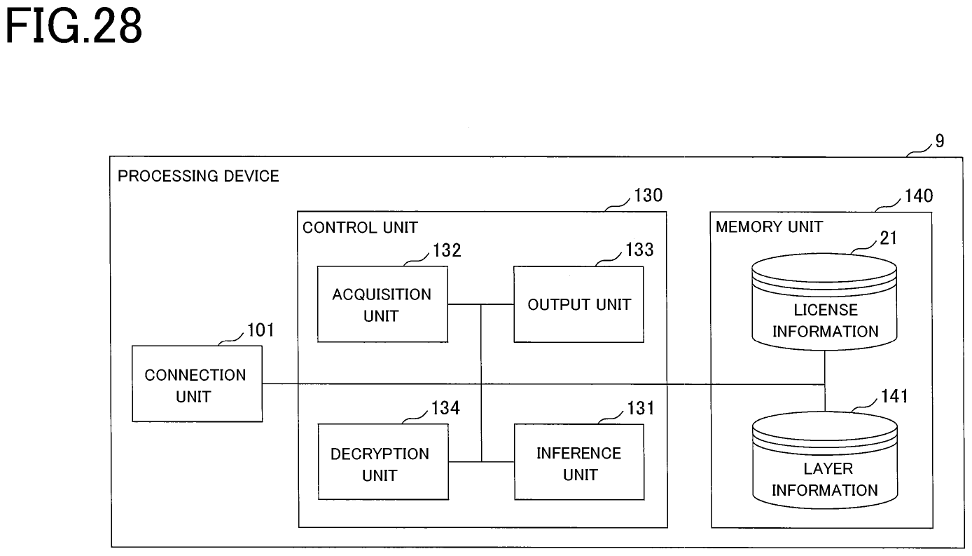

FIG. 28 is a functional block diagram illustrating one mode of the processing apparatus according to the fourth embodiment.

Processing to be performed by the processing apparatus 9 is described with reference to FIG. 28.

The processing apparatus 9 according to the fourth embodiment includes a control unit 130, a memory unit 140, and the connection unit 101. The configuration of the processing apparatus 9 is such that an inference unit 131 and the layer information 141 are added to the configuration of the processing apparatus 8 according to the third embodiment. In the following descriptions, the inference unit 131, the layer information 141, and changed functions of an acquisition unit 132, an output unit 133, and a decryption unit 134, whose functions are partly changed with the addition of the inference unit 131 and the layer information 141, are described, and descriptions of other elements are omitted. The processing apparatus 9 may include a determination unit that determines whether the encrypted learned model input from the customer apparatus 5C has been encrypted, by referring to an encryption identifier.

When having acquired data to be input to the layer information 141 from the customer apparatus 5C, the inference unit 131 performs an operation of the layer information 141. The output unit 101 outputs an operation result of the layer information 141 to the customer apparatus 5C. The data to be input to the layer information 141 is, for example, output data of the convolutional layer 720 illustrated in FIG. 26. The operation result of the layer information 141 is, for example, output data of the pooling layer 733 illustrated in FIG. 26. When the layer information 141 has been encrypted, the decryption unit 133 decrypts the layer information 141. The inference unit 131 performs the operation of the layer information 141 by using the decrypted layer information 141.

The acquisition unit 132 acquires the layer information 141 from the development apparatus 6B and memorizes the layer information 141 in the memory unit 140.

When an encrypted learned model excluding the layer information 141 is input from the customer apparatus 5C, the decryption unit 134 decrypts an obfuscated common key included in the license information 21. Further, the decryption unit 134 uses the decrypted common key to decrypt the encrypted learned model excluding the layer information 141. The output unit 133 outputs the encrypted learned model excluding the decrypted layer information 141 to the customer apparatus 5C.

As described above, the processing apparatus 9 memorizes therein the second learned model that includes the structure and the weight of the second operation of the neural network including the first operation including one or more layers and the second operation including one or more other layers. The processing apparatus 9 performs the second operation by using the second learned model.

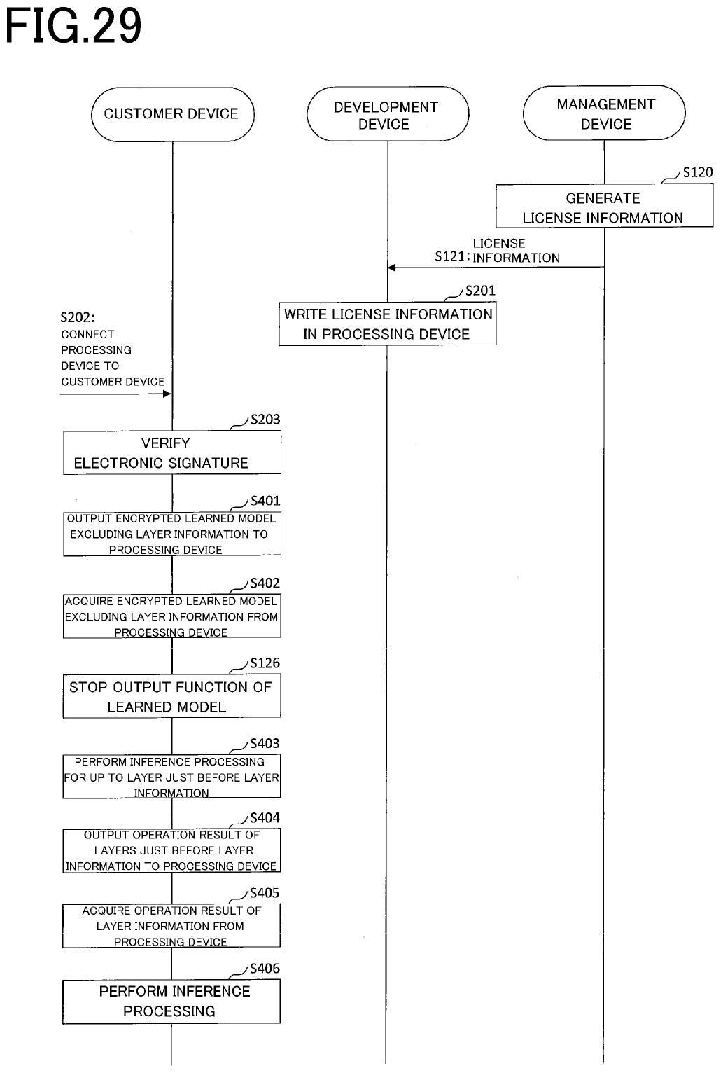

FIG. 29 is a sequence diagram illustrating an example of processing to be performed in the processing system according to the fourth embodiment.

Processing to be performed in the processing system 600 according to the fourth embodiment is described with reference to FIG. 29. In the following descriptions, for simplifying the explanations, processing to be performed by the control unit 80c of the customer apparatus 5C, the control unit 90b of the development apparatus 6B, and the control unit 60 of the management apparatus 3 is described as the processing performed by the customer apparatus 5C, the development apparatus 6B, and the management apparatus 3.

In the processing performed by the processing system 600 according to the fourth embodiment, processes at S401 to S406 described below are added, instead of processes at S127, S301, and S302 performed by the processing system 500 according to the third embodiment. In the following descriptions, processes at S401 to S406 are described, and descriptions of other processes are omitted.

When the processing apparatus 9 is connected to the customer apparatus 5C, for example, by a user (S202), the customer apparatus 5C acquires the license information 21 from the processing apparatus 9, and verifies an electronic signature included in the acquired license information 21 (S203). When the electronic signature cannot be authorized, the customer apparatus 5C ends the process.

When the electronic signature is authorized, the customer apparatus 5C outputs an encrypted learned model excluding the layer information 141 to the processing apparatus 9 (S401). Accordingly, the customer apparatus 5C causes the processing apparatus 9 to decrypt the encrypted learned model excluding the layer information 141.

The customer apparatus 5C acquires the decrypted learned model excluding the layer information 141 from the processing apparatus 9 (S402). The customer apparatus 5C stops the function of outputting the information on the encrypted learned model (S126).

The customer apparatus 5C uses the learned model excluding the layer information 141 to perform inference processing for up to a layer just before the layer information 141 (S403). Next, the customer apparatus 5C outputs an operation result of the layers up to the layer just before the layer information 141 to the processing apparatus 9 (S404). Accordingly, the customer apparatus 5C causes the processing apparatus 9 to perform the operation of the layer information 141.

The customer apparatus 5C acquires the operation result of the layer information 141 from the processing apparatus 9 (S405). The customer apparatus 5C uses the operation result of the layer information 141 to perform an operation from a layer just after the layer information 141 up to the output layer (S406).

As described above, since the customer apparatus 5C according to the fourth embodiment causes the processing apparatus 9 to perform a part of the operation of the inference processing, the customer apparatus 5C enables a full effect of the inference processing without requiring an output of the information including the network structure, the weight, and the bias of a part of layers from the processing apparatus 9. Therefore, the customer apparatus 5C can prevent leakage of the network structure and the weight included in the learned model.

Further, the processing apparatus 9 according to the fourth embodiment performs the operation of the layer information 141 corresponding to continuous three or more layers included in the neural network in the processing apparatus 9. Therefore, the customer apparatus 5C can perform the inference processing in a state in which input/output information on at least one layer of the layer 730 is hidden. Accordingly, the customer apparatus 5C can prevent leakage of the structure and the weight included in the learned model.

In the above descriptions, the customer apparatus 5C causes the processing apparatus 9 to decrypt the encrypted learned model excluding the layer information 141. However, the decryption unit 83 may decrypt the encrypted learned model excluding the layer information 141. In this case, the inference unit 88 performs the inference processing by using the learned model excluding the layer information 141 decrypted by the decryption unit 83.

In the above descriptions, the customer apparatus 5C acquires the encrypted learned model excluding the layer information 141. However, the acquisition unit 86 may acquire the learned model excluding the layer information 141. In this case, when the learned model excluding the layer information 141 is input, the inference unit 88 performs the first operation by using the learned model excluding the layer information 141, and causes the processing apparatus 9 to perform the second operation by using the layer information 141, thereby performing the inference.

In the above descriptions, the processing apparatus 9 performs the operation of the continuous three or more layers included in the neural network. However, the operation is not limited thereto, and the processing apparatus 9 may perform an operation of arbitrary one or more layers included in the neural network. Accordingly, since the processing apparatus 9 can perform an operation of a volume matched with the computing capacity thereof, a decrease in the speed of the inference processing resulting from the operation speed of the processing apparatus 9 can be suppressed.

In the processing system 600 according to the fourth embodiment, it has been described that a developer of a learned model creates an application that uses the learned model. However, the application may be created by an application developer different from the developer of the learned model. In this case, the encrypted learned model may be provided from the developer of the learned model to a customer via the application developer.

Also in a case where an encrypted learned model is provided to a customer via the application developer, decryption of an obfuscated common key is automatically performed by performing an inverse operation to the operation used at the time of generating the obfuscated common key in the inference DLL. That is, the application developer develops the application and the customer uses the application without knowing the contents of the learned model. Accordingly, in the processing system 600, the contents of the learned model are used without being known by a person other than the developer of the learned model. Therefore, the processing system 600 can promote collaboration between the developer of the learned model and the application developer, while reducing the risk such that the learned model is misused without permission.

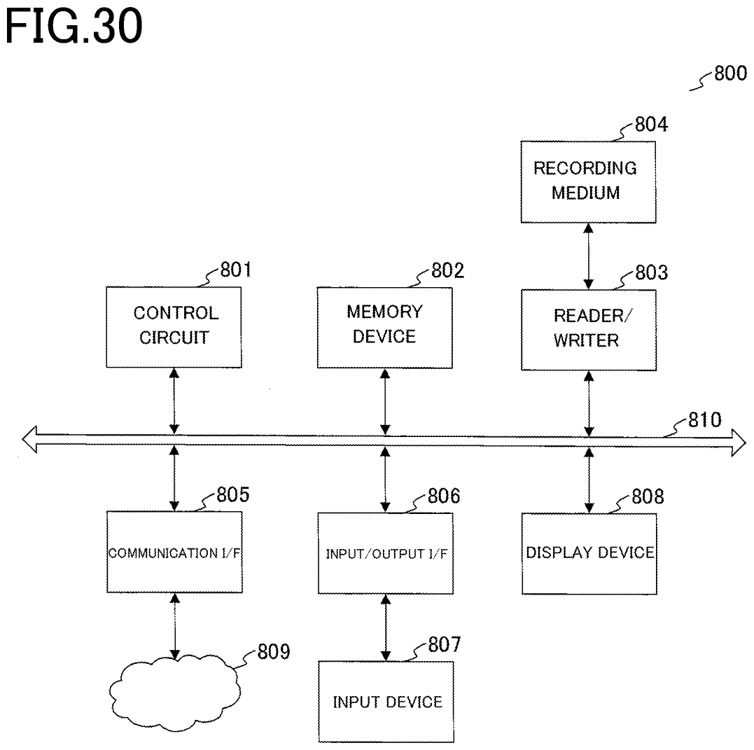

FIG. 30 is a block diagram illustrating an example a computer apparatus.

A configuration of a computer apparatus 800 is described with reference to FIG. 30.

In FIG. 30, the computer apparatus 800 includes a control circuit 801, a memory device 802, a reader/writer 803, a recording medium 804, a communication interface 805, an input/output interface 806, an input device 807, and a display device 808. The communication interface 805 is connected a network 809. The respective constituent elements are connected to each other by a bus 810. The customer apparatuses 1, 5A, 5B, and 5C, the development apparatuses 2, 6A, and 6B, the management apparatus 3, and the processing apparatuses 7, 8, and 9 can be configured by appropriately selecting a part of or all of the constituent elements of the computer apparatus 800.

The control circuit 801 controls the entirety of the computer apparatus 800. The control circuit 801 is, for example, a processor such as a Central Processing Unit (CPU) and a Field Programmable Gate Array (FPGA). Further, the control circuit 801 functions, for example, as a control unit of the respective apparatuses described above.

The memory device 802 memorizes therein various pieces of data. The memory device 802 is, for example, a Read Only Memory (ROM), a Random Access Memory (RAM), and a Hard Disk (HD). For example, the memory device 802 functions as, for example, a memory unit of the respective apparatuses described above.

Further, the ROM stores therein a program such as a boot program. The RAM is used as a work area of the control circuit 801. The HD stores therein an OS, a program such as firmware and an application program, and various pieces of data. The memory device 802 may memorize therein a program causing the control circuit 801 to function as a control unit of the respective apparatuses described above. The program causing the control circuit 801 to function as a control unit of the respective apparatuses described above is, for example, the framework, the encryption tool, the inference DLL, and the application described above. Each of the framework, the encryption tool, the inference DLL, and the application may include a part of or all of the programs causing the control circuit 801 to function as a control unit of the respective apparatuses described above.

The respective programs described above may be memorized in a memory apparatus held by a server in the network 809, if the control circuit 801 can access the memory apparatus via the communication interface 805.

The reader/writer 803 is controlled by the control circuit 801 to perform read and write of data with respect to the detachable recording medium 804. The reader/writer 803 is, for example, a Disk Drive (DD) of various kinds and a Universal Serial Bus (USB).

The recording medium 804 stores therein various pieces of data. The recording medium 804 stores therein a program, for example, that functions as a control unit of the respective apparatuses described above. Further, the recording medium 804 may store therein at least one of the inference information 4a illustrated in FIG. 1, FIG. 13, and FIG. 19, and the inference information 4b illustrated in FIG. 24. Read and write of data is performed by connecting the recording medium 804 to the bus 810 via the reader/writer 803, which is controlled by the control circuit 801.

Further, the recording medium 804 is, for example, a non-transitory computer-readable recording medium such as an SD Memory Card (SD), a Floppy Disk (FD), a Compact Disc (CD), a Digital Versatile Disk (DVD), a Blu-ray® Disk (BD), and a flash memory.

The communication interface 805 communicably connects the computer apparatus 800 with other apparatuses via the network 809. Further, the communication interface 805 may include an interface having a function of a wireless LAN, and an interface having a Near Field Communication function. LAN is an abbreviation for Local Area Network.

The input/output interface 806 is connected with the input device 807 such as a keyboard, a mouse, and a touch panel, and the processing apparatus described above, and when a signal indicating various pieces of information is input from the input device 807, and the processing apparatus connected therewith, the input/output interface 806 outputs the input signal to the control circuit 801 via the bus 810. Further, when a signal indicating various pieces of information output from the control circuit 801 is input via the bus 810, the input/output interface 806 outputs the signal to various apparatuses connected therewith. Further, the input/output interface 806 functions, for example, as a connection unit of the respective apparatuses described above.

The input device 807 may receive an input of setting of, for example, a hyperparameter of the framework for learning.

The display device 808 displays thereon various pieces of information. The display device 808 may display thereon information for receiving an input by the touch panel. The display device 808 functions as the display device 30, for example, connected to the customer apparatuses 1, 5A, 5B, and 5C.

The input/output interface 806, the input device 807, and the display device 808 may function as a GUI.

The network 809 is, for example, a LAN, a wireless communication, or the Internet, and connects communication between the computer apparatus 800 and other apparatuses.

The present embodiment is not limited to the embodiment described above, and can employ various configurations or other types of embodiment without departing from the scope of the present embodiment.

In the following descriptions, the customer apparatuses 1, 5A, 5B, and 5C are also simply referred to as “customer apparatus”, when these apparatuses are not particularly distinguished from each other. Further, the development apparatuses 2, 6A, and 6B are also simply referred to as “development apparatus”, when these apparatuses are not particularly distinguished from each other. Further, the management apparatus 3 is also simply referred to as “management apparatus”. The storage apparatus 4 is also simply referred to as “storage apparatus”. Further, the processing apparatuses 7, 8, and 9 are also simply referred to as “processing apparatus”, when these apparatuses are not particularly distinguished from each other.

In the first to fourth embodiments, the common key has been explained to be obfuscated and provided to the customer apparatus. However, a secret key and a public key generated by the management apparatus may be provided to the customer apparatus.

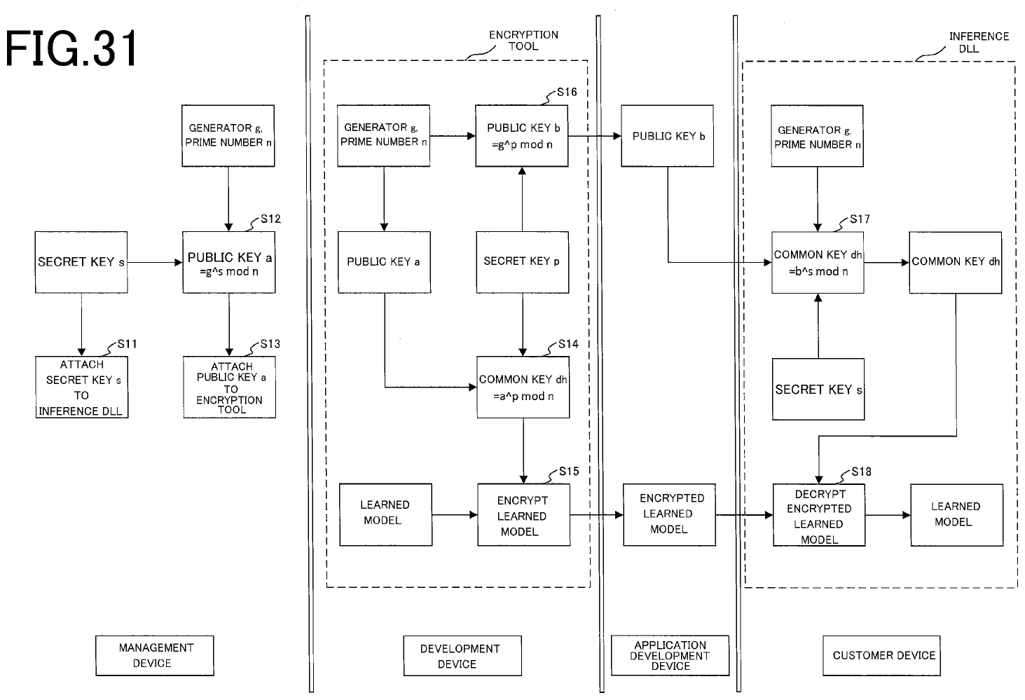

As a first example corresponding to a configuration in FIG. 31 described below, a first generation unit of the management apparatus generates a first secret key and a first public key corresponding to the first secret key. The learning unit of the development apparatus performs learning for adjusting the weight of a learned model. Further, a second generation unit of the development apparatus generates a second secret key, a common key using the first public key and the second secret key, and a second public key corresponding to the second secret key. The development apparatus encrypts a learned model by using the common key generated by the second generation unit.

The customer apparatus determines whether the encrypted learned model has been input by the determination unit. Further, a third generation unit (not illustrated) of the customer apparatus generates a common key by using the first secret key and the second public key. When the learned model is input, the decryption unit of the customer apparatus decrypts the learned model by using the common key generated by the third generation unit. The inference unit of the customer apparatus performs inference by using the learned model decrypted by the decryption unit. The third generation unit is included in, for example, the control unit of the customer apparatus.

FIG. 31 is a diagram illustrating one mode of a processing system using DH key exchange.

A process of providing a common key using DH key exchange (Diffie-Hellman key exchange) is described with reference to FIG. 31. In the following descriptions, it is assumed that a generator g and a prime number n are set by the management apparatus and shared by the development apparatus and the customer apparatus. It is also assumed that the encryption tool and the inference DLL each include information enclosed by a broken line to perform a process enclosed by the broken line. Further, an application development apparatus is an information processing apparatus used by an application developer and is, for example, a computer apparatus illustrated in FIG. 30 described above. The application developer is, for example, a developer who develops an application. The application is, for example, software that performs inference processing by using a learned model developed by the development apparatus.

The management apparatus generates a secret key s and attaches the secret key s to the inference DLL (S11). At S11, the management apparatus may further attach the generator g and the prime number n to the inference DLL, so that the generator g and the prime number n are shared with the customer apparatus. In the following descriptions, it is assumed that the management apparatus attaches the generator g and the prime number n to the inference DLL.

Further, the management apparatus sets the generator g and the prime number n, and substitutes the generator g, the prime number n, and the secret key s into the following expression (1) to obtain a public key a (S12).

Public key a=g^{\hat{ }s} mod n→ (1)

The management apparatus attaches the public key a to the encryption tool (S13). At S13, the management apparatus may further attach the generator g and the prime number n to the encryption tool to share the generator g and the prime number n with the development apparatus. In the following descriptions, it is assumed that the management apparatus attaches the generator g and the prime number n to the encryption tool.

The development apparatus executes the encryption tool to generate a secret key p, and substitutes the public key a attached to the encryption tool and the secret key p into the following expression (2) to obtain a common key dh (S14).

Common key dh=a^{\hat{ }p} mod n→ (2)

The development apparatus uses the common key dh to encrypt the learned model (S15).

Further, the development apparatus substitutes the generator g, the prime number n, and the secret key p attached to the encryption tool into the following expression (3) to obtain a public key b (S16).

Public key b=g^{\hat{ }p} mod n→ (3)

The application development apparatus acquires an encrypted learned model and the public key b from the development apparatus, and creates an application that performs the inference processing by using the learned model. In the following descriptions, it is assumed that the encrypted learned model and the public key b are provided to a customer together with the application from the application developer. However, the encrypted learned model and the public key b may be directly provided to a customer from the developer of the learned model.

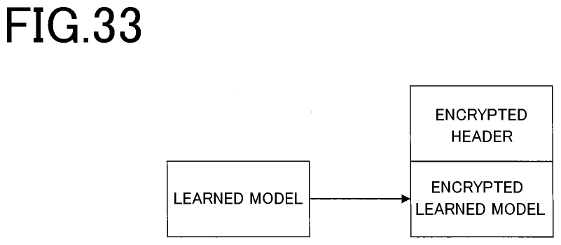

Further, as illustrated in FIG. 33, the public key b may be stored in an encrypted header attached to the encrypted learned model by the development apparatus and provided to a customer. Further, the encrypted header may store therein at least one of, for example, a product name, an encrypted common key, a customer name, an expiration date, a device identifier, an electronic signature, and author information included the license information 21. Further, an encryption identifier may be stored in the encrypted header. In this case, information included in the encrypted header is provided to a customer by using the encrypted header as a medium, instead of a license file or a dongle. The author information is, for example, information for identifying the developer of the learned model. Further, in the first to fourth embodiments, at least one piece of information included in the license information 21 may be stored in the encrypted header, instead of the license file. Also in this case, the information included in the encrypted header is provided to a customer by using the encrypted header as a medium, instead of the license file or the dongle.

When the public key b is input, the customer apparatus substitutes the secret key s, the generator g and the prime number n attached to the inference DLL, and the public key b into the following expression (4), to obtain a common key dh.

Common key dh=b^{\hat{ }s} mod→ (4)

When an encrypted learned model is input, the customer apparatus uses the common key to decrypt the encrypted learned model to acquire the learned model.

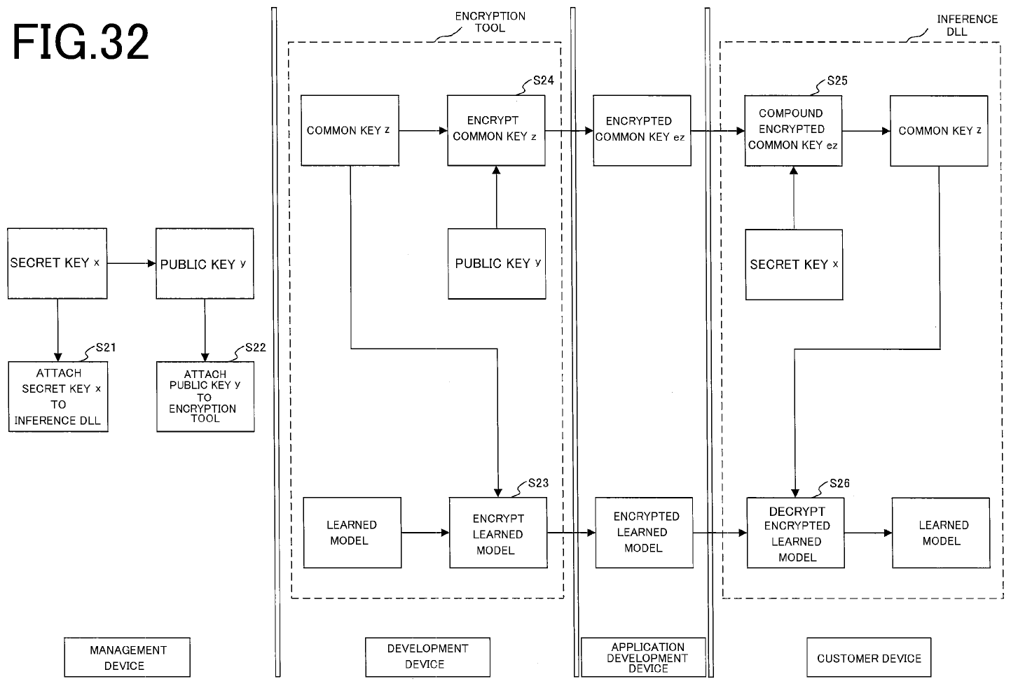

As a second example corresponding to the configuration in FIG. 32 described later, the first generation unit of the management apparatus generates a secret key, and a public key corresponding to the secret key. The learning unit of the development apparatus adjusts the weight of the learned model. Further, the second generation unit of the development apparatus generates a common key. The encryption unit of the development apparatus encrypts the common key by using the public key and encrypts the learned model by using the encrypted common key.

The determination unit of the customer apparatus determines whether the encrypted learned model has been input. Further, the decryption unit of the customer apparatus decrypts the encrypted common key encrypted by the encryption unit of the development apparatus by using the secret key, and decrypts the encrypted learned model by using the decrypted common key. The inference unit of the customer apparatus performs inference by using the learned model decrypted by the decryption unit.

FIG. 32 is a diagram illustrating one mode of an encryption processing system using public key cryptography.

A process of providing a common key by using the public key cryptography is described with reference to FIG. 32. It is assumed that the encryption tool and the inference DLL each include information enclosed by a broken line to perform a process enclosed by the broken line.

The management apparatus generates a secret key x and attaches the secret key x to the inference DLL (S21). Further, the management apparatus uses the secret key x to generate a public key y corresponding to the secret key x, and attaches the public key y to the encryption tool (S22).

The development apparatus sets a common key z and encrypts a learned model by using the common key z (S23). Further, the development apparatus encrypts the common key z by using the public key y attached to the encryption tool (S24).

The application development apparatus acquires the encrypted learned model and an encrypted common key ez from the development apparatus, to create an application that performs the inference processing by using the learned model. In the following descriptions, it is assumed that the encrypted learned model and the encrypted common key ez are provided from the application developer to a customer together with the application. However, the encrypted learned model and the encrypted common key ez may be directly provided from a developer of the learned model to the customer.

Further, as illustrated in FIG. 33, the public key ez may be stored in the encrypted header attached to the encrypted learned model and provided to the customer by the development apparatus. Further, the encrypted header may store therein at least one of, for example, a product name, an encrypted common key, a customer name, an expiration date, a device identifier, an electronic signature, and author information included the license information 21. Further, the encrypted header may store therein an encryption identifier. In this case, the information included in the encrypted header is provided to the customer by using the encrypted header as a medium, instead of the license file or the dongle.

When the encrypted common key ez is input, the customer apparatus uses the secret key x attached to the inference DLL to decrypt the encrypted common key ez to acquire the common key z. Upon input of the encrypted learned model, the customer apparatus decrypts the encrypted learned model by using the common key z to acquire the learned model.

According to the configuration described above, unless the secret key included in the inference DLL leaks, decryption of the encrypted common key cannot be performed, and thus leakage of the public key can be prevented.

Further, decryption of the encrypted common key is automatically performed in the inference DLL by using the secret key. That is, the application developer develops the application and the customer uses the application without knowing the contents of the learned model. Accordingly, in the processing system illustrated in FIG. 31 and FIG. 32, the contents of the learned model are used without being known by a person other than the developer of the learned model. Therefore, the processing system illustrated in FIG. 31 and FIG. 32 can promote collaboration between the developer of the learned model and the application developer, while reducing the risk such that the learned model is misused without permission.

In the above descriptions, it is assumed that the application developer is a developer different from the developer of the learned model, in order to specify the effect attained by the processing system illustrated in FIG. 31 and FIG. 32. However, the application developer and the developer of the learned model may be the same.

FIG. 33 is a diagram illustrating one mode of the encrypted header of the encrypted learned model.

A modification of the encrypted learned model is described with reference to FIG. 33.

In the first to fourth embodiments, it has been described that the license information 21 is written in a license file or a dongle. However, as illustrated in FIG. 33, the license information 21 may be stored in the encrypted header attached to a learned model. That is, at least one of a product name, an encrypted common key, a customer name, an expiration date, a device identifier, an electronic signature, an encryption identifier, and author information included the license information 21 may be included in the encrypted header attached to the learned model.

More specifically, the development apparatus stores the license information 21 and the encryption identifier in the encrypted header attached to the encrypted learned model and stores the encrypted header in the storage apparatus. The customer apparatus issues an acquisition request of the encrypted learned model to the development apparatus. In response to the acquisition request, the development apparatus provides the encrypted learned model stored in the storage apparatus to the customer apparatus. At this time, the development apparatus may rewrite the expiration date and the electronic signature stored in the encrypted header. In the processing system, the storage apparatus may rewrite the expiration date and the electronic signature. In this case, the storage apparatus may receive an acquisition request of the encrypted learned model from the customer apparatus, and provide the encrypted learned model to the customer apparatus by rewriting the expiration date and the electronic signature stored in the encrypted header.

According to the configuration described above, the processing system according to the present embodiment can set an expiration date according to an acquisition request from the customer apparatus, when the customer apparatus acquires an encrypted learned model. Accordingly, the processing system according to the present embodiment can perform an operation suitable for a distribution service of a learned model. In the distribution service of a learned model, acquisition of an encrypted learned model by the customer apparatus may be performed, for example, via the development apparatus, or may be performed by directly downloading the encrypted learned model from the storage apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

1. An inference apparatus comprising:
a processor which executes a process, wherein
the process includes:
outputting information representing contents of a learned model of a neural network,
determining whether encrypted learned model in which the learned model is encrypted, has been input,
stopping the outputting process, when the encrypted learned model is input,
decrypting the encrypted learned model, when the encrypted learned model is input, and
performing inference by using the decrypted learned model.

2. The inference apparatus according to claim 1, wherein
the process executed by processor further includes:
transmitting an issuance request of license information including a first device identifier for identifying a device included in the inference apparatus to a learning apparatus that generates a learned model,
acquiring license information including the first device identifier from the learning apparatus, and
the decrypting process executed by the processor further including
decrypting the encrypted learned model, upon input of the encrypted learned model, when the first device identifier and a second device identifier for identifying any one device included in the inference apparatus match with each other.

3. The inference apparatus according to claim 2, wherein
the license information further includes a decryption key for decrypting the encrypted learned model, and
the decrypting process executed by the processor further including
decrypting the encrypted learned model by using the decryption key.

4. The inference apparatus according to claim 2, wherein
the license information further includes an expiration date of the encrypted learned model, and
the decrypting process executed by the processor further including
decrypting the encrypted learned model, when a time at a time of decrypting the encrypted learned model is within the expiration date.

5. The inference apparatus according to claim 2, further comprising:
a connection interface that is detachably connected to a processing apparatus that stores therein the license information, wherein
the acquiring process executed by the processor further including
acquiring license information from the processing apparatus, when the processing apparatus is connected to the connection interface.

6. The inference apparatus according to claim 1, wherein
the encrypted learned model is attached with an encryption identifier for identifying whether the learned model has been encrypted, and
the determining process executed by the processor further including
determining whether the encrypted learned model has been input, by referring to the encryption identifier.

7. An inference apparatus comprising:
a connection interface detachably connected to a processing apparatus; and
a processor which executes a process, wherein
the process includes:
outputting information representing contents of a learned model of a neural network,
determining whether first encrypted data, in which first data corresponding to a first operation of one or more layers included in the learned model is encrypted, has been input,
stopping the outputting process, when the first encrypted data is input,
decrypting the first encrypted data, when the first encrypted data is input, and
performing inference by performing the first operation by using the first data, and by causing the processing apparatus to perform a second operation of a layer excluding the one or more layers from the learned model, wherein
the processing apparatus memorizes therein second data corresponding to the second operation and performs the second operation by using the second data.

8. The inference apparatus according to claim 7, wherein
the processing apparatus further has a function of decrypting the first encrypted data, and
the process executed by processor further includes:
instead of the decrypting process, acquiring the first data, by causing the processing apparatus to decrypt the first encrypted data, when the first encrypted data is input.

9. The processing apparatus according to claim 7, wherein the second operation includes an operation of continuous three or more layers included in a neural network.

10. An inference method executed by a processor, the inference method comprising:
a process executed by the processor including
outputting information representing contents of a learned model of a neural network,
determining whether encrypted learned model in which the learned model is encrypted, has been input,
stopping the outputting process, when the encrypted learned model is input,
decrypting the encrypted learned model, when the encrypted learned model is input, and
performing inference by using the decrypted learned model.

11. A non-transitory computer-readable recording medium therein a inference program for causing a processor to execute a inference process, the process comprising:
outputting information representing contents of a learned model of a neural network,
determining whether encrypted learned model in which the learned model is encrypted, has been input,
stopping the outputting process, when the encrypted learned model is input,
decrypting the encrypted learned model, when the encrypted learned model is input, and
performing inference by using the decrypted learned model.
